(19) United States
(12) Patent Application Publication
(10) Pub. No.: US 2025/0286769 A1
(43) Pub. Date: Sep. 11, 2025

(54) Synthesizing Network Specifications Using Input and Output Examples

(71) Applicants: The Trustees of the University of Pennsylvania, Philadelphia, PA (US); University of Southern California, Los Angeles, CA (US)

(72) Inventors: Boon Thau LOO, Cherry Hill, NJ (US); Haoxian CHEN, Shanghai (CN); Mayur Hiru NAIK, Flourtown, PA (US); Chenyuan WU, Bellevue, WA (US); Andrew Junyl ZHAO, Princeton, NJ (US); Mukund RAGHOTHAMAN, Los Angeles, CA (US)

(21) Appl. No.: 18/902,091

(22) Filed: Sep. 30, 2024

Related U.S. Application Data
(60) Provisional application No. 63/541,219, filed on Sep. 28, 2023.

(51) Int. Cl. G06F 16/2457; G06F 16/242

(52) U.S. Cl. CPC H04L 41/0226

(57) ABSTRACT

Methods, systems, and computer readable media for synthesizing network specifications using input and output examples are disclosed. An example system for synthesizing network specifications using input and output examples includes a processor and a memory. The system also includes an network specification synthesizer (NSS) implemented using the processor and the memory. The NSS is configured for: receiving input and output examples associated with a network protocol; generating, using the input and output examples and a synthesis algorithm, a logical specification defining the network protocol, wherein the logical specification includes a set of rules; and outputting the logical specification.

### PRIORITY CLAIM

This application claims the priority benefit of U.S. Provisional Patent Application Ser. No. 63/541,219, filed Sep. 28, 2023, the disclosure of which is incorporated herein by reference in its entirety.

### GOVERNMENT INTEREST

This invention was made with government support under N00014-20-1-2635 awarded by the Office of Naval Research and CCF-2107429, CCF-2107261, CCF-2124431, CNS-2104882, CNS-2107147 awarded by the National Science Foundation. The government has certain rights in the invention.

### TECHNICAL FIELD

The subject matter described herein relates to synthesizing network specifications. More particularly, the subject matter described herein relates to methods, systems, and computer readable media for synthesizing network specifications using input and output examples.

### BACKGROUND

Formal specifications are vital for a wide range of networking tasks, including verification, analysis, and debugging. Network operators who seek to verify properties of their networks need a formal specification of the network's protocols. In cloud management, cluster administrators who wish to ascertain reachability of nodes must specify the desired behavior using declarative queries. In distributed systems, programmers who wish to verify certain system properties rely on formal specifications of a wide range of protocols, including inter-domain routing, consensus protocols, and security protocols. Furthermore, various domain-specific languages rely on formal specifications expressed in logic as a basis for generating actual implementations, thereby bridging the specifications-implementation divide.

Despite their promising benefits, formal specifications have not yet gained mainstream adoption in practice. Today, it remains challenging for a network practitioner to write these formal specifications in the first place. It is even harder to ensure that the specifications capture all aspects of the network. Formal languages have steep learning curves, and it is difficult to find engineers who are simultaneously well-versed in network operations and formal methods. Consequently, despite the progress in tools for network verification and analysis, undertaking these tasks may necessitate a formal methods expert who can at least write the desired properties or model the network in formal specification languages.

### SUMMARY

Methods, systems, and computer readable media for synthesizing network specifications using input and output examples are disclosed. An example system for synthesizing network specifications using input and output examples includes a processor and a memory. The system also includes an network specification synthesizer (NSS) implemented using the processor and the memory. The NSS is configured for: receiving input and output examples associated with a network protocol; generating, using the input and output examples and a synthesis algorithm, a logical specification defining the network protocol, wherein the logical specification includes a set of rules; and outputting the logical specification.

An example method for synthesizing network specifications using input and output examples includes receiving input and output examples associated with a network protocol; generating, using the input and output examples and a synthesis algorithm, a logical specification defining the network protocol, wherein the logical specification includes a set of rules; and outputting the logical specification.

The subject matter described herein may be implemented in hardware, software, firmware, or any combination thereof. As such, the terms “function”, “node”, or “module” as used herein refer to hardware, which may also include software and/or firmware components, for implementing the feature(s) being described. In some exemplary implementations, the subject matter described herein may be implemented using a computer readable medium having stored thereon computer executable instructions that when executed by the processor of a computer control the computer to perform steps. Exemplary computer readable media suitable for implementing the subject matter described herein include non-transitory computer readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

The subject matter described herein will now be explained with reference to the accompanying drawings of which:

FIG. 1 is a diagram illustrating an example system for synthesizing network specifications using input and output examples;

FIG. 2 is a flow chart illustrating an exemplary process for synthesizing network specifications using input and output examples;

FIG. 3A is a diagram of an example network topology as a weighted directed graph (left), a relational representation of the topology (middle), and expected output (right) for shortest path routing;

FIG. 3B illustrates a network protocol specification for shortest path routing automatically synthesized by NetSpec for the topology illustrated in FIG. 3A;

FIG. 4 is a diagram illustrating the NetSpec synthesis procedure. On the left is the input table. The dashed boxes show the three intermediate programs leading up to the final solution. The tables under the boxes describe their respective outputs;

FIG. 5 illustrates two solutions of routing protocols specified with incomplete examples. The difference is indicated by the dashed boxes.

FIG. 6 illustrates abstract syntax of specification in NetSpec. Input relation (1), output relation (O), user-defined functions (F), and aggregation (A) are application-specific;

FIG. 7 is a table illustrating an example of scoring a partial program Pr;

FIG. 8 is a table illustrating synthesis results for benchmarks where the original examples are sufficient;

FIG. 9 is a table illustrating active learning results for benchmarks that need example augmentation;

FIG. 10 is a graph illustrating results indicating that NetSpec solves more benchmarks as the number of random samples in active learning increases; and

FIG. 11 illustrates graphs of random drop examples.

### DETAILED DESCRIPTION

The subject matter described herein relates to synthesizing network specifications and includes methods, techniques, and mechanisms for generating network specifications using input and output examples.

Reference will now be made in detail to various examples of the subject matter described herein, examples of which are illustrated in the accompanying drawings. Wherever possible, the same reference numbers will be used throughout the drawings to refer to the same or like parts.

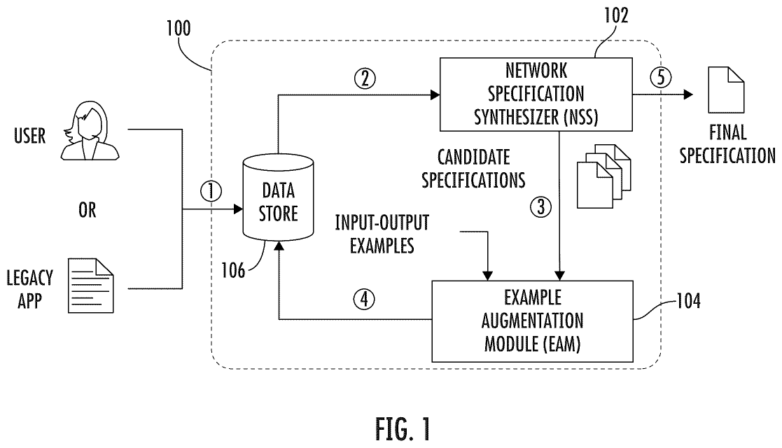

FIG. 1 is a diagram illustrating an example system 100 (e.g., a single or multiple processing core computing device) for synthesizing network specifications using input and output examples. System 100 may include any suitable entity or entities, such as a test tool, a network device, or one or more computing devices or platforms software executing on a processor, a logic device, a complex programmable logic device (CPLD), a field-programmable gate array (FPGA), and/or an application specific integrated circuit (ASIC). System 100 may be configured for performing one or more aspects of the present subject matter described herein or described in sections under the heading below entitled, “Synthesizing Formal Network Specifications from Input-Output Examples.”

In some examples, components, modules, and/or portions of system 100 may be implemented or distributed across multiple devices or computing platforms. For example, system 100 may involve one or more computers configured to perform various functions, such as receiving input and output examples associated with a network protocol; generating, using the input and output examples and a synthesis algorithm, a logical specification defining the network protocol, wherein the logical specification includes a set of rules; and/or outputting the logical specification.

In some examples, system 100 or related entities may include one or more processor(s) and memory. For example, processor(s) may be configured to execute software stored in one or more non-transitory computer readable media. In this example, software may be loaded into a memory structure for execution by processor(s). In another example, e.g., where system 100 includes multiple processors, some processor(s) may be configured to operate independently of other processor(s).

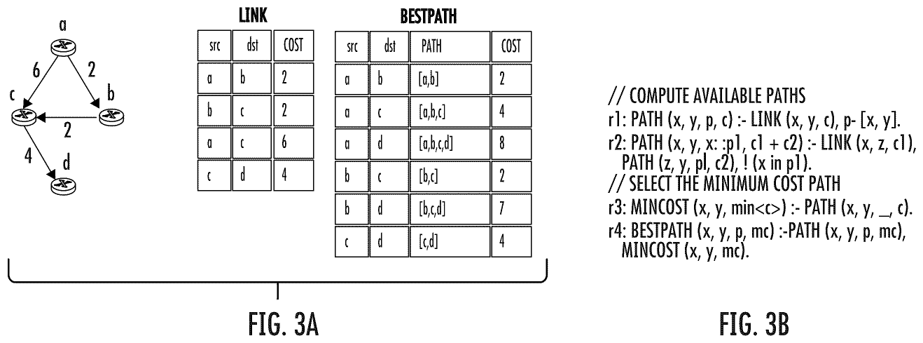

Referring to FIG. 1, system 100 may include a network specification synthesizer (NSS) 102, an example augmentation module (EAM) 104, and a data store 106. NSS 102 may represent any suitable entity (e.g., software executing on one or more physical processors) for synthesizing network specifications using input and output examples. NSS 102 may generate a network specification (e.g., an executable program or logical specification expressed as rules in a Datalog or Datalog-like language) based on input and output examples. For example, a user (e.g., a network operator) may provide network protocol information as a set of pair of input and output examples. For example, an input example may include tuples indicating network topology information (e.g., hop counts between various points in a network) and a corresponding output example may indicate a lowest cost or lowest numbers of hops between various points in the network (including points that have multiple routes or paths). In this example, the input and output examples (e.g., like examples described in FIGS. 3A and 3B and Section 2 below) may be provided to NSS 102 from a user or data store 106 (e.g., a device or memory for storing algorithms, input data, output data, or other information).

In some examples, NSS 102 or a synthesis algorithm thereof may utilize different kinds of input. For example, one kind of input may include a set of input-output example pairs, where each pair includes a set of input tables, and a set of output tables. Such tables may be relational, where each row is interpreted as relational tuples in Datalog or a Datalog like language. In this example, an optional kind of input may include a list of user-defined functions and aggregators that could appear in the output specification. Additional and related details regarding logical specifications and related syntax are discussed in Section 3 and various other sections described below.

In some examples, where a legacy application or a network protocol implementation is available and/or is to be analyzed, NSS 102 or another entity of system 100 may obtain or generate actual program execution traces by executing the legacy application or implementation and capturing execution traces and/or related information. For example, NSS 102 or a synthesis algorithm thereof may use input and output examples using program execution traces derived from a popular open-source software defined networking (SDN) controller implementation (e.g., one written in Floodlight and POX) and then use those examples in generating a logical specification that is consistent with the implementation.

In some examples, after receiving input and output examples, NSS 102 or a synthesis algorithm thereof (e.g., Algorithm 1 described in Section 4 below) may use the input and output examples (and optionally information regarding the output specification) to generate or synthesize a logical specification consistent with the input and output examples. For example, NSS 102 or a synthesis algorithm thereof (e.g., Algorithm 1 described in Section 4 below) may utilize a novel best-first search algorithm that incrementally generates simple to complex specifications, with the ability to rapidly backtrack, which enables efficient exploration of an unbounded search space and produces succinct specifications. In contrast, existing techniques may either require the user to bound the search space (e.g., by providing the maximum number of operators), or suffer in terms of efficiency by exploring a large number of incorrect specifications.

In some examples, starting with an empty program, with score 0, a synthesis algorithm may repeatedly generate offspring specifications (also referred to herein as offspring programs) by applying all mutation strategies, and adds these offspring into a set of candidate specifications (also referred to herein as candidate programs). In such examples, the next specification to mutate is sampled from offspring that have higher scores, or the whole set of candidate programs when no offspring has a higher score. Additional and related details are discussed with regard to sampling algorithm 2 and Section 4 below.

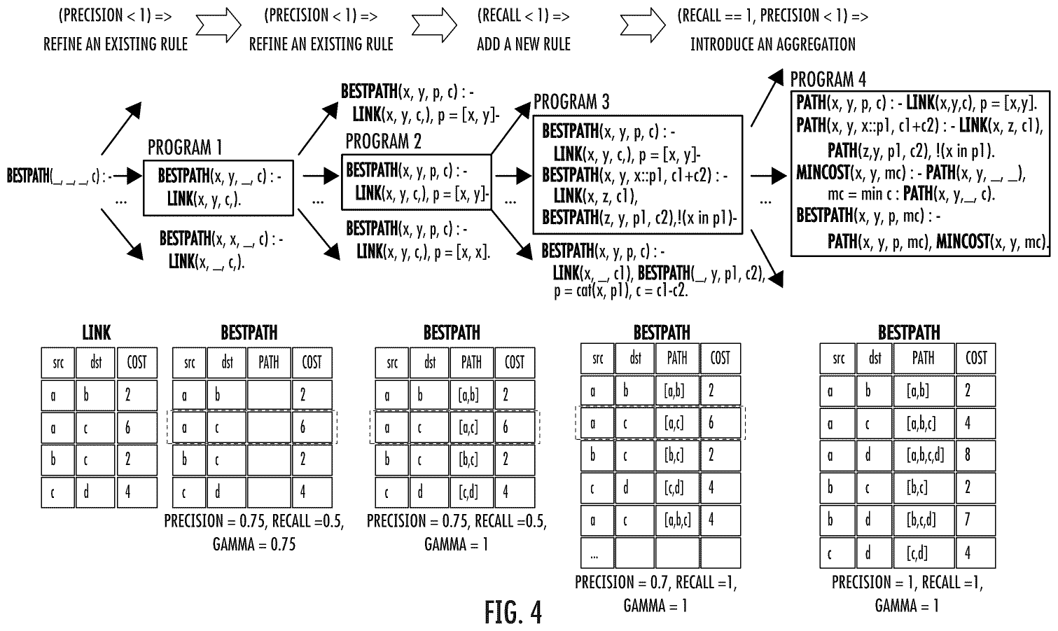

In some examples, mutation strategies may be applied based on various factors. In such examples, a synthesis algorithm may mutate a current best candidate specification by adding rules, extending or refining rules (e.g., introducing literals), and/or applying an aggregation operator. For example, a synthesis algorithm or a related search algorithm may begin by enumerating single rule specifications which produce at least one expected output tuple. The same rule generation algorithm may also be invoked when an intermediate specification fails to produce a desired output tuple, e.g., it has imperfect recall (less than 1), e.g., as determined by a scoring algorithm like formula 1 or Algorithm 2 described below in Sections 2 and 4. In this example, each synthesized rule may be is chosen so that it produces at least one desirable tuple which is currently missing and these rules may be synthesized by repeatedly introducing literals to the set of minimal rules, which contain only one head literal and one body literal, until it produces at least one expected output tuple. In some scenarios, a candidate specification may apply an aggregation operator when needed, e.g., when a specification produces the expected output but also produces additional incorrect output, i.e., it has perfect recall but imperfect precision. Additional and related details are discussed with regard to candidate programs (1-4) in FIG. 4 and Sections 3 and 4 below.

EAM 104 may represent any suitable entity (e.g., software executing on one or more physical processors) for augmenting input and output examples, e.g., when the provided examples are incomplete or insufficient for generating a logical specification. For example, given an initial set of input-output examples, when multiple satisfying specifications are found, NSS 102 or a related entity may search for a new input example that can differentiate these candidate specifications, and may ask a user to specify the expected output for this new input example. By actively querying the user for feedback, this allows NSS 102 or a related entity to robustly learn specifications even from a set of initially under-specified examples. Additional and related details are discussed with regard to sampling algorithm 4 and Section 5 below.

In some examples, system 100 or another entity (e.g., an analyzer or interpreter) may provide or use a generated or synthesized logical specification for various purposes, e.g., for verification, analysis, or prototyping purposes. For example, a prototyping tool may perform rapid prototyping of a protocol design by compiling a synthesized logical specifications into distributed implementations. Additional and related details regarding advantages and uses of NSS 102 or related output are discussed in Section 1 and various other sections below.

Referring to FIG. 1, in step 1, input may be received by system 100. For example, input may include user input (e.g., one or more pairs of input and output examples, sets of tuples, etc.) or a legacy application (e.g., an SDN controller application). In this example, the input can be received via one or more communications interfaces (e.g., an application programming interface (API), a command line interface (CLI), a graphical user interface (GUI), etc.) and may be stored in data store 106 (e.g., a data storage device or a memory).

In step 2, the input may be provided to NSS 102 and may be used (e.g., by a synthesis algorithm thereof) when generating or attempting a final or output specification that is consistent with the input.

In step 3, while generating or attempting a final specification, NSS 102 or a related algorithm may generate a set of candidate specifications that are consistent with the input. For example, NSS 102 or a related algorithm may generate a set of candidate specifications when received input and output examples are incomplete or insufficient to identify one final specification.

In step 4, EAM 104 may use the candidate specifications and the input (e.g., a pair of input and output examples) to generate a supplemental input example for obtaining additional input from a user. For example, EAM 104 may use the candidate specifications and the input (e.g., a pair of input and output examples) to generate a supplemental input example (e.g., a permutation of an existing input example) and then may request and receive a supplemental output example that corresponds to the supplemental input example.

In step 5, the supplemental examples may be provided to NSS 102 and may be used along with the original input (e.g., by a synthesis algorithm thereof) to generate a final or output specification that is consistent with all the input.

It will be appreciated that FIG. 1 is for illustrative purposes and that various nodes, their locations, and/or their functions may be changed, altered, added, or removed. For example, some nodes and/or functions may be combined into a single entity. In a second example, a node and/or function may be located at or implemented by two or more nodes.

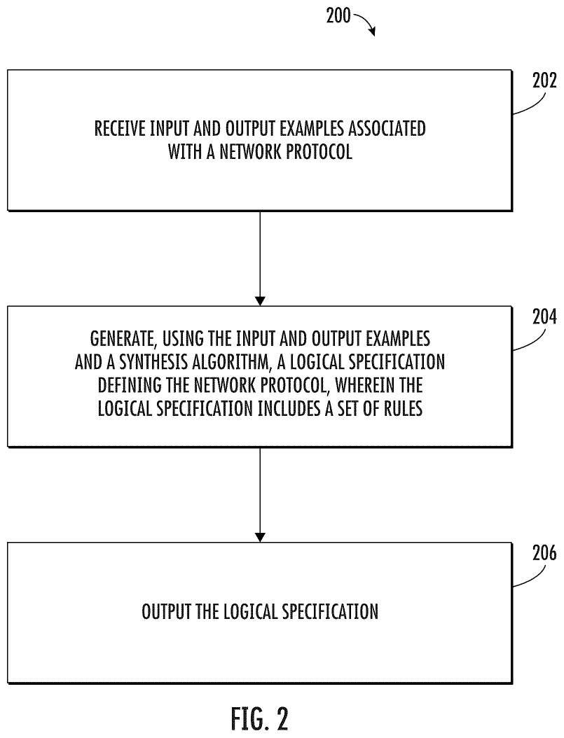

FIG. 2 is a flow chart illustrating an exemplary process 200 for synthesizing network specifications using input and output examples. In some examples, process 200, or portions thereof (e.g., steps 202, 204, and/or 206), may be performed by or at system 100, NSS 102, EAM 104, and/or another node or module.

Referring to process 200, in step 202, input and output examples associated with a network protocol may be received. For example, NSS 102 or a related algorithm (e.g., a synthesis algorithm) may receive and use an input example (such as a set of input tuples like a topology table indicating network topology information (e.g., each row or tuple may indicate a cost or number of hops between two nodes or points in the network)) and a corresponding output example (such as a set of output tuples like a best path or lowest cost table ((e.g., each row or tuple may indicate a lowest cost or least number of hops between two nodes or points in the network)).

In step 204, a logical specification defining the network protocol may be generated using the input and output examples and a synthesis algorithm. In some examples, a generated or synthesized logical specification may include a set of rules. For example, a synthesis algorithm may generate rules that executable and may be expressed in a declarative logical specification language (e.g., Datalog or a Datalog-like language).

In step 206, the logical specification may be outputted. For example, after generating a logical specification, NSS 102 may provide the logical specification to another entity (e.g., a module or system) for various purposes.

In some examples, a logical specification (e.g., generated by NSS 102 or a related entity) may be expressed using a declarative logic programming language, Datalog, or an extended Datalog like language.

In some examples, a synthesis algorithm (e.g., usable by NSS 102) may comprises or perform various steps or actions in generating a logical specification (also referred to herein as a formal specification, a network specification, or a program) comprising one or more rules (e.g., in a Datalog or Datalog like language).

In some examples, a synthesis algorithm (e.g., usable by NSS 102) may include detecting incompleteness in the input and output examples used in generating the logical specification; generating a supplemental input example usable for generating the logical specification; requesting and receiving, from a user (e.g., an NSS or network operator), a supplemental output example corresponding to the supplemental input example; and utilizing the supplemental input and output examples in generating the logical specification.

In some examples, a synthesis algorithm (e.g., usable by NSS 102 to generate a logical specification) may utilize a best-first search algorithm that incrementally explores an unbounded search space in synthesizing rules of a logical specification.

In some examples, a best-first search algorithm (e.g., usable by NSS 102 or a related synthesis algorithm) may include performing an iterative loop until a stop condition is reached (e.g., no additional candidate specifications are found or needed). In such examples, the iterative loop may include various actions including mutating, using at least one mutation strategy, a first candidate specification to generate a plurality of offspring candidates, where each of the plurality of offspring candidates are scored; and selecting, from the plurality of offspring candidates and using scores of the plurality of offspring candidates, a second candidate specification to mutate.

In some examples, where a plurality of candidate specifications is generated and scored, a second candidate specification selected for mutation (e.g., by a synthesis algorithm or a best-first search algorithm) may be selected from offspring candidates of a plurality of offspring candidates that have higher scores or is selected from the plurality of offspring candidates when none of the plurality of offspring candidates has a higher score.

In some examples, at least one mutation strategy may include adding a new rule, extending an existing rule (e.g., refinement by adding literals), or applying an aggregation operator.

In some examples, input and output examples (e.g., usable by NSS 102 or a related synthesis algorithm) may include input-output pair, such as a first input example and a first output example. In such examples, the first input example may include network information, topology information, virtual machine (VM) configuration information, link cost information, or a weighted directed graph and the first output example includes network state information, shortest or best path information, or reachable VM pair information.

In some examples, NSS 102 or another entity may utilize traces or monitoring of runtime executions of the network protocol to obtain or derive the input and output examples.

In some examples, NSS 102 or another entity may use a generated logical specification for verification, analysis, or prototyping purposes.

In some examples, NSS 102 or another entity may be configured for executing, using a compiler or interpreter, a logical specification and monitoring the execution of the logical specification for issues. For example, a SDN controller may execute a logical specification generated by NSS 102 and then monitor the execution for potential issues (e.g., bugs or mishandled data).

It should be noted that system 100, NSS 102, EAM 104, and/or functionality described herein may constitute a special purpose computing device. Further, system 100, NSS 102, EAM 104, and/or functionality described herein can improve the technological field of network testing, debugging, prototyping, and/or analysis.

### Synthesizing Formal Network Specifications from Input-Output Examples

We propose NetSpec, a tool that synthesizes network specifications in a declarative logic programming language from input-output examples. NetSpec aims to accelerate the adoption of formal verification in networking practice, by reducing the effort and expertise required to specify network models or properties. NetSpec aims to be i) highly expressive, capable of synthesizing network specifications with complex semantics; ii) scalable, by virtue of using a novel best-first search algorithm to efficiently explore an unbounded solution space, and iii) robust, avoiding the need for exhaustive input-output examples by actively generating new examples. Our experiments demonstrate that NetSpec can synthesize a wide range of specifications used in network verification, analysis, and implementations. Furthermore, improves upon existing approaches in terms of expressiveness, robustness to examples, and the quality of synthesized programs.

### 1. Introduction

Formal specifications are vital for a wide range of networking tasks, including verification [20], [5], [6], [40], [41], analysis [4], [26], [9], and debugging [11], [43]. Network operators who seek to verify properties of their network need a formal specification of the network's protocols [20]. In cloud management, cluster administrators who wish to ascertain reachability of nodes must specify the desired behavior using declarative queries [4], [26]. In distributed systems, programmers who wish to verify certain system properties rely on formal specifications of a wide range of protocols, including inter-domain routing [41], [20], [6], consensus protocols [3], [37], and security protocols [12]. Furthermore, various domain specific languages [31], [25], [17], [7] rely on formal specifications expressed in logic as a basis for generating actual implementations, thereby bridging the specifications-implementation divide.

Despite their promising benefits, formal specifications have not yet gained mainstream adoption in practice. Today, it remains challenging for a network practitioner to write these formal specifications in the first place. It is even harder to ensure that the specifications capture all aspects of the network. Formal languages have steep learning curves, and it is difficult to find engineers who are simultaneously well-versed in network operations and formal methods. Consequently, despite the progress in tools for network verification and analysis, undertaking these tasks still necessitates a formal methods expert who can at least write the desired properties or model the network in formal specification languages.

According to an aspect of the subject matter described herein, we present NetSpec, a specification-by-example (SBE) toolkit that aims to automatically synthesize formal specifications of network protocols in logic. NetSpec aims to make formal network analysis more accessible to network programmers, who do not necessarily have expertise in formal methods. In the SBE paradigm, programmers provide input-output examples of their protocol designs. These designs can be handwritten or derived from actual runtime communication traces. NetSpec then applies program synthesis techniques to automatically yield the logical specifications which are amenable to verification [40] or generation of distributed implementations [25].

Our choice of logic as a basis for NetSpec is motivated by the fact that many formal network models trace their roots to logical specifications. In particular, we target an extension of the declarative logic programming language Datalog [2], which is popular in the literature on network verification [20], [17], [5], [40], [41], analysis [31], [4], [26], debugging [43], [11], and implementation [31], [25], [3], [37]. Thus, our logical specifications can be seen as declarative programs in themselves: the input comprises facts about a network (e.g., topology, VM configurations, etc.) or incoming messages (e.g., route requests), while the output comprises actual network state (e.g., the shortest path, the reachable VM pairs, etc.) or outgoing messages (e.g., route updates).

We envision NetSpec being used in a variety of settings:
1. verifying network protocols at design time by providing input-output examples that can be proof-checked based on its synthesized logical specifications. When a design bug is revealed by a verifier, the user can correct the design by adding new examples.
2. rapid prototyping of a protocol design by compiling the synthesized logical specifications into distributed implementations; and
3. taking a legacy program and deriving its logical specifications from runtime executions for subsequent verification or software analysis. When a verifier finds a counter-example, it can be used to test against the legacy program. If the legacy program exhibits undesired behavior, a real bug is caught. Otherwise, the logical specifications are inaccurate, and can be refined by adding the counter-example to NetSpec.

To this end, NetSpec provides features that advance upon state-of-the-art programming-by-example approaches and enable it to effectively address the above use-cases. We next elucidate each of these features:
Expressivity. NetSpec supports expressive features necessitated by complex semantics involved in network specifications. These features include recursion, aggregation, and user-defined functions (UDFs). None of the existing techniques for synthesizing declarative programs support this combination of features, which precludes them from targeting many common network specifications, e.g., routing protocols and consensus protocols.
Scalability. NetSpec uses a novel best-first search algorithm that incrementally proceeds from simple to complex programs, with the ability to rapidly backtrack, which enables to efficiently explore an unbounded search space and produce succinct specifications. In contrast, existing techniques either require the user to bound the search space [24], [33](e.g., by providing the maximum number of operators), or suffer in terms of efficiency by exploring a large number of incorrect programs [28].
Robustness. NetSpec is robust to the quality of input-output examples. Approaches based on programming-by-example rely on the user to craft a complete set of examples in order to learn the correct program. However, it is easy to miss corner cases when providing these examples manually. NetSpec proactively detects the incompleteness in the specified examples, and generates new input queries to the example provider—a network operator or a legacy implementation. These new inputs, together with the provider's answers as the outputs, improve the example quality and enable NetSpec to unambiguously learn a correct program.

We have developed a prototype of NetSpec and evaluate it on a suite of 26 benchmarks that encompass a wide range of network protocols in different sub-domains, including network analysis, software-defined networking (SDN), sensor networks, routing protocols, and consensus protocols. Our experiments demonstrate that NetSpec can faithfully synthesize most logical specifications in under a few seconds, with the most complex one in slightly more than 1 minute. In contrast, state-of-the-art tools GenSynth [28] and Scythe [42] cannot synthesize benchmarks requiring either aggregation or user-defined functions (10 out of 26), and benchmarks requiring recursion or user-defined functions (11 out of 26), respectively. Moreover, the specifications synthesized by NetSpec can be directly compiled into declarative networking for distributed implementations.

To validate NetSpec on actual implementations, we further demonstrate that NetSpec is able to synthesize logical specifications from actual program execution traces derived from popular open-source SDN controller implementations written in Floodlight [19] and POX [32], highlighting its ability to synthesize specifications for large-scale programs. To summarize, exemplary technical contributions of the subject matter described herein are as follows:
We propose a novel synthesis algorithm to efficiently synthesize highly expressive network specifications from input-output examples. The specifications, expressed in first-order relational logic, have a variety of uses including verifying, analyzing, and generating implementations.
Since programming-by-example approaches are susceptible to missing examples, we develop a novel example generation algorithm to supplement synthesis. It queries the example provider for new examples that guide the synthesis algorithm to an unambiguous specification.
We realize our approach in a tool NetSpec and evaluate it on diverse benchmarks and use-cases. NetSpec is able to correctly synthesize a wide-range of network protocols within seconds and is robust to missing examples. Moreover, we demonstrate that NetSpec outperforms state-of-the-art synthesis approaches in terms of its expressiveness, and in the quality of its synthesized programs.

### 2. Illustrative Example

In this section, we illustrate the end-to-end operation of NetSpec using the shortest path routing protocol as an example. The overall architecture of NetSpec is depicted in FIG. 1. In Sections 2.1, 2.2, and 2.3, we describe the input-output examples, the synthesis algorithm, and the example augmentation process respectively.

### 2.1 Problem Specification

NetSpec takes two kinds of input: (1) A set of input-output example pairs, where each pair consists of a set of input tables, and a set of output tables. These tables are relational, where each row is interpreted as relational tuples in Datalog. (2) Optionally, a list of user-defined functions and aggregators that could appear in the output specification. And NetSpec returns a logical specification, in the syntax of Datalog, that is consistent with the input-output examples. In the remainder of the description herein, we will use “specification” and “program” to refer to NetSpec's output interchangeably.

FIG. 3A depicts such an example for our shortest path routing protocol. In this example, one input-output pair is provided. The input table is named link, describing the network topology as a weighted graph. And the output table is named bestPath, specifying an optimal path for each pair of source and destination nodes. Functions including list initialization (l=[x, y]), concatenation (x::l), and membership checking (xinl), and aggregators (min and max) are also provided.

From this data, NetSpec automatically synthesizes the declarative logical specification shown in FIG. 3B. We have expressed the specification using the syntax for Datalog, which we briefly review in Section 3. The first two rules specify paths between pairs of nodes and their associated costs: rule r1 specifies a network link as a one-hop path, and rule r2 specifies the transitive case. In particular, x::p1 prepends node x to the head of path p1, and !(x in p1) checks that x is not in path p1, to avoid generating loops and to enforce termination. Rules r3 and r4 select the path with the minimum cost as the output best path.

This specification provides a high-level abstraction for verifying route convergence properties [41] and explaining route derivations [45]. Similarly, logical specification of other routing protocols can also be used to reason about network connectivity under different network dynamics [26], [20].

Despite the simplicity of the final specification, several aspects of the synthesis problem make it challenging in practice. First, the search space is enormous. For example, the rule r2 contains 13 variable occurrences, so that there are 13!≈10⁹ ways of filling in its variables even after the rest of the rule structure is fixed. Furthermore, interaction between the rules makes the problem non-compositional, and techniques which synthesize one rule at a time become inapplicable [30], [15]. Finally, because input-output examples often under-specify the target concept and because of the undecidability of program equivalence [2], it is difficult to determine whether the synthesized specification correctly captures the user's intent.

### 2.2 Synthesis by Optimization

We organize the synthesis algorithm as an optimization problem and illustrate the process in FIG. 4. Each node in the figure represents a candidate program, and its outgoing edges indicate each of its possible offspring. We highlight critical steps that lead to the final program and defer details of the algorithm to the next two sections.

Conceptually, we consider three possible modifications to each candidate program: introducing rules, introducing literals within a rule, and introducing aggregation operators. In the rest of this section, we first describe the overall search strategy for applying the modifications, and then outline each one of the three modification steps.

Search strategies. The objective function of the optimization problem is based on two measures of success on a candidate program s:

$$score ( s ) = precision ( s ) \times recall ( s ) \qquad ( 1 )$$

In particular, given the set of expected output tuples Oₑₓₚ, and a candidate specification s that produces set of output tuples Oᵣₑₜ, we calculate precision(s)=|Oₑₓₚ∩Oᵣₑₜ|/|Oᵣₑₜ|, which is the fraction of tuples produced which are expected, and recall(s)=|Oₑₓₚ∩Oᵣₑₜ|/|Oₑₓₚ, which is the fraction of expected tuples which are produced by the candidate specification. The score(s) is discounted by a γ(s) metric that is a fraction of columns whose column values are all known given s.

Starting with an empty program, with score 0, the synthesis algorithm repeatedly generates offspring programs by applying all mutation strategies, and adds these offspring into a set of candidate programs. The next program to mutate is sampled from offspring that have higher scores, or the whole set of candidate programs when no offspring has a higher score.

In FIG. 4, the input relation link generates 3 of the 6 expected bestPath tuples in Programs 1 and 2. For instance, the rule bestPath(x,y,p,c):-link(x,y,c), p=[x,y] has a recall of 0.5 and a precision of 0.75, and has the highest score among all candidate programs. The dashed boxes indicate a bestPath tuple denoting the shortest path from a to c is incorrect and needs to be fixed. Moreover, some bestPath tuples are missing. In subsequent steps, the candidate program with the highest score is successively modified to include the transitive rule for paths, and the aggregation operation to select the optimum weight path. Eventually, the tuple in the dashed boxes is corrected, the missing tuples are generated, and we converge on the best paths that matches the given input-output examples.

We next describe the three modification steps that can be applied to the current best candidate program. Each modification is described by referencing the generated candidate programs (1-4) in FIG. 4.

Modification 1: Introducing new rules. The algorithm begins by enumerating single rule programs which produce at least one expected output tuple. The same rule generation algorithm is also invoked when the intermediate program fails to produce a desired output tuple, i.e., it has imperfect recall (less than 1). Each synthesized rule is chosen so that it produces at least one desirable tuple which is currently missing. These rules are synthesized by repeatedly introducing literals (modification 2) to the set of minimal rules, which contain only one head literal and one body literal, until it produces at least one expected output tuple.

We illustrate this process for the running example in FIG. 4. Midway through running the best-first search algorithm after two refinement steps, the precision and recall of the best candidate program are 0.75 and 0.5, respectively. At this point, the best candidate program is only able to generate one-hop best paths by virtue of the rule bestPath(x,y,p,c):-link(x,y,c),p=[x,y](Program 2). New rules need to be added so that one can generate outputs for paths that are two-hops and beyond, and this is done by adding the recursive rule that contains bestPath in the rule body. Upon adding this new rule, the recall of the resulting output (Program 3) is increased to 1 although the precision is still not yet 1 (pending one additional modification to introduce aggregates).

Modification 2: Rule refinement by introducing literals. If the precision of a candidate program is less than 1, the algorithm adds new constraints to its rules by introducing literals, or by augmenting them with aggregation operations. By adding new literals to its rules, the algorithm produces an offspring program s′ which produces a subset of the output tuples produced by the original program s.

To provide some intuition on rule refinement, we consider the scenario shown in FIG. 4 where the current best candidate is the partial rule bestPath(x,y,_,c):-link(x,y,c) (Program 1). Since the third column of the output relation has not yet been specified, the algorithm scores this partial rule by only comparing the remaining columns to the reference output. Intuitively, the partial rule mispredicts the cost of the (a,c) path, so that the program has a precision of 0.5 and a recall of 0.75. This score is additionally discounted by a factor of γ=0.75 to account for incompleteness in output and bias the rule search towards faster rule completion. At this point, the rule refinement adds a literal p=[x, y] where [ ] is a path concatenation function which is one of the candidate user-defined functions provided to the synthesis algorithm. Interestingly, with this refinement, while precision is unchanged in the resulting output (Program 2), γ increases to 1 and all column values are known.

Observe that this process of adding literals provides flexibility in supporting arbitrary functions because it makes no assumptions about the underlying semantics. It is also highly efficient because it only considers one literal at a time, instead of arbitrary combinations of literals.

Modification 3: Aggregation operators. The final way to modify a program output is to apply an aggregation operation to produce one of its output columns. Consider the rule r3 which finds the length of the shortest path between x and y. Informally, the aggregation operator min first groups the output tuples by their source and destination nodes, (x,y), and then aggregates over all possible values of c for which a path exists: path(x,y,_,c). In FIG. 4, after adding the min aggregate to a candidate (Program 3), the algorithm converges upon the final solution (Program 4).

### 2.3 The Example Augmentation Process

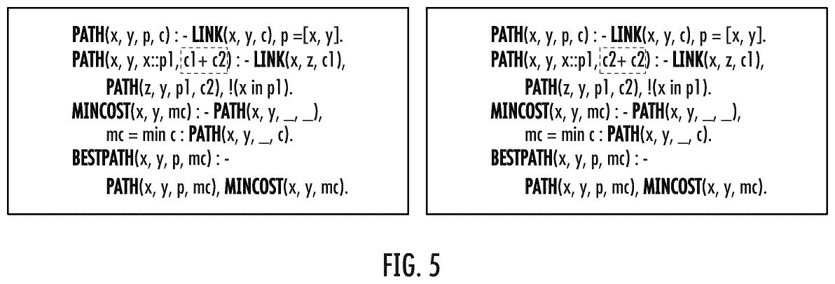

The synthesis algorithm discovers all programs which are consistent with the input-output examples up to a maximum depth. When the provided input-output examples only partially constrain the possible solutions, the algorithm may discover multiple solutions, all of which are consistent with the data. We show two possible solutions to the shortest path routing program in FIG. 5 and highlight their differences in the dashed boxes. In general, dealing with under-constrained specifications is a major outstanding challenge in programming-by-example (PBE) systems, and solution disambiguation is a contribution of the subject matter described herein.

One reason for the difficulty of disambiguation is that the equivalence checking problem for Datalog programs is undecidable [2]. To address this, Netspec employs the idea of differential testing from program analysis [27] to repeatedly run the two programs with randomly perturbed inputs. In our example, by modifying the link costs, one obtains an input which reveals the difference between the two programs. We can then request the user to provide the ground truth for this new example, which will in turn eliminate at least one of the candidate solutions. The process repeats until only one program remains, or NetSpec fails to generate a distinguishing input among the programs. In this latter case, NetSpec produces the simplest program as the final solution. Because the enumeration process is biased towards smaller programs, and because the tie-breaking routine favors the syntactically smallest solution, in practice NetSpec produces small programs that are also readily interpretable and resistant to over-fitting.

### 3. The NetSpec Specification Language

This section provides a more formal overview of the language of specifications synthesized by NetSpec. The design of the language is motivated by two goals: the ability to express a wide range of network specifications, and the ability to leverage a variety of network verifiers, analyzers, and implementations.

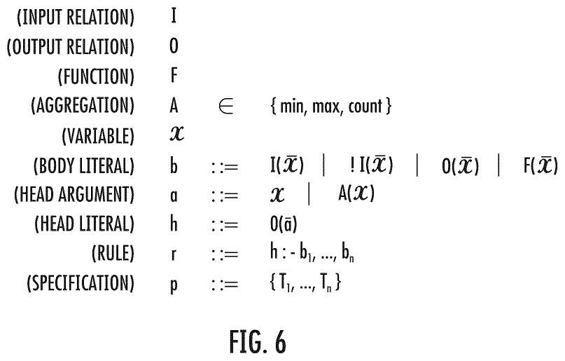

FIG. 6 presents the abstract syntax of specifications. We elucidate it using our running example of the shortest-path routing specification shown in FIG. 3B. A specification is a program whose inputs and outputs are a set of relations. In our routing example, the input relations include link, which represents the network topology, as well as common predicates such as in (list membership). The output relations include bestPath, which represents the shortest path between every pair of nodes in the input network, as well as relations such as path and minCost which hold intermediate results needed to compute bestPath.

A specification comprises a set of rules that specify how to compute the output relations from the input relations. Our routing example comprises four rules denoted r1 through r4. Each rule is a Horn clause of the form: $${R_h}(\bar{x_h})\\mbox{{\tt:-}}\{R_1}(\bar{x_1}), . . . , {R_n}(\bar{x_n})$$ where the x̅ₜ's are vectors of variables of appropriate arity. Each rule is read from right-to-left as a universally quantified implication: for all variable valuations x, if each of tuples R₁(x̅₁), . . . , Rₙ(x̅₄) are derivable, then so is Rₕ(x̅ₕ).

For instance, rule r4 in our routing example states that if ${\\tt path}(x,y,p,mc)$ and ${\tt minCost}(x,y,mc)$ are derivable, then so is ${\tt bestPath}(x,y,p,mc)$. This rule also depicts a basic logic operation: conjunction (i.e., join). On the other hand, disjunction (i.e., union) is expressed by means of different rules with the same head relation, as illustrated by rules r1 and r2 which denote the base case and inductive step, respectively, for computing the path relation. These two rules also illustrate recursion—an operation commonly needed in network specifications to specify reachability properties.

The features described thus far constitute the declarative logic programming language Datalog [2]. However, Datalog is inadequate to express real-world network specifications with rich functionality. The specification language of NetSpec therefore extends Datalog with three additional kinds of operations: negation (denoted !), aggregation (e.g., min and count), and user-defined functions, which include common utility functions such as :: (list prepend) and +(integer addition). To ensure well-founded semantics (Datalog programs with negations should be stratified [2, Chapter 15]), NetSpec only applies negations to input relations or functions, e.g., to function in in rule r2. In addition, to keep the synthesis task tractable, NetSpec applies the following syntactic restrictions to each rules:
1. Each rule can have at most 2 literals of the same relation. For example, a rule h(x,w):-p(x,y), p(y,z), p(z,w) would not be generated by NetSpec because it has 3 literals of relation “p”.
2. A negation literal can have at most 2 bound variables. For example, literal !p(a, b, c) would not be added to rules, because it has 3 bound variables (a, b, c). But literal !p(a, b, _) could be added.
3. At most one aggregation is used in each program.
4. Aggregation can only be applied in the head of a rule. For instance, applying min in rule r3 yields the minimum cost c over all paths between each pair of nodes x and y in the input network.
5. A user-defined function's result can only be used in the head of a rule, e.g., the result of + in rule r2.

In evaluation, we show that these syntactic restrictions have no impact on all declarative specifications from prior literature, except PAXOS, which has two layers of aggregations. We show how to synthesize such complex protocols by breaking it down into independent modules in Section 7.1.

Specifications are executable programs: execution begins with all output relations initialized to empty, and proceeds by repeatedly evaluating the rules until the output relations stop changing. The syntactic restrictions described above ensure a deterministic result regardless of rule evaluation order. However, note that the presence of recursion together with user-defined functions can lead to non-termination (e.g., by recursively applying integer addition). NetSpec thus supports a highly expressive class of specifications.

An important benefit of the specifications synthesized by NetSpec is their suitability for a variety of networking tasks. They can be verified using SDN verifiers such as Vericon [5] and FlowLog [31], and routing verifiers such as Batfish [20] and FSR [41]; They can be analyzed using network analysis tools such as NOD [26], Tiros [4] and ExSPAN [45]. Lastly, they can be compiled to distributed implementations in Network Datalog [25] and FlowLog [31].

### 4. Synthesis Algorithm

Algorithm 1 Synth (I, O, F). Given a set of input tuples I, expected to
output tuples O, and a library of functions F, produces all consistent
programs.

| | | |
|---|---|---|
| 1. | | Initialize the set of solutions, S := Ø, the set of candidate programs, |
| | | Q := {P₀}, and the current program P := P₀, where P₀ is the |
| | | empty program. |
| 2. | | While Q ≠ Ø, do: |
| | a. | Let Offspring(P) = {P′₁, P′₂, . . . } be the offspring of P, computed |
| | | according to Equation 2. |
| | b. | Update the set of solutions, and add all remaining programs for |
| | | further enumeration: |
| | | S := S ∪ {P′ ϵ Offspring(P) \| score(P′) = 1}, and |
| | | Q := (Q\P) ∪ {P′ ϵ Offspring(P) \| score(P′) > 0}. |
| | | c. Sample the next program to explore: |
| | | HS := {P′ ϵ Offspring(P) \| score(P′) > score(P)} |
| | | HR := {P′ ϵ Offspring(P) \| recall(P′) > recall(P)} |
| | | $P := \{ \begin{matrix}Sample ( HS , P ) & if HS \neq ∅ \\ Sample ( HR , P ) & else if HR \neq ∅ \\ Sample ( Q , P ) & otherwise .\end{matrix}$ |
| 3. | | Return S. |
| | | $\begin{matrix}Offspring ( P ) = {O}_{D} ( P ) ⋃ {O}_{C} ( P ) ⋃ {O}_{A} ( P ) , where \\ {O}_{D} ( P ) = \{ \begin{matrix}AddRule ( P ) & if recall ( P ) < 1 , and \\ ∅ & otherwise ,\end{matrix} \\ {O}_{C} ( P ) = \{ \begin{matrix}ExtRule ( P ) & if precision ( P ) \leq 1 , and \\ ∅ & otherwise , and\end{matrix} \\ {O}_{A} ( P ) = \{ \begin{matrix}MkAgg ( P ) & if precision ( P ) \leq 1 and \\ & recall ( P ) = 1 , and \\ ∅ & otherwise .\end{matrix}\end{matrix} \qquad ( 2 )$ |

We present the top-level synthesis procedure in Algorithm 1. It takes only a set of input tuples (I), and a set of output tuples (O), and we will explain how to support multiple instances of input-output example pairs in section 4.4. As described in Section 2, it models an optimization problem in the Datalog program space, where each state is a program. And the objective function score(p) is defined as the product of precision(p) and recall(p).

At each iteration, the algorithm explores the program space by mutating the current program P, which gives rise to several offspring (step 2a). Offspring(P) is defined in equation 2, where the D, C, and A subscripts indicate the generation of offspring by adding new rules (disjunctions), extending existing rules (conjunctions), and by applying aggregation operators, respectively. The conditions to apply each of these mutation strategies are based on the semantics of Datalog. Both adding clause in a conjunction rule, and aggregate the output of current program, monotonically decrease the size of program output (number of tuples), thus may improve precision, but may also lower recall at the same time. Thus they are only applied when the program has imperfect precision. Adding a rule, on the contrary, monotonically increase the size of program output, and could potentially improve recall, but lower precision at the same time. Therefore it is only applied when the program has imperfect recall. In addition, we assume the program space where only one aggregator is used, thus we wait until all necessary rules are added to reach perfect recall before applying aggregation.

In step 2b, offspring with score 1 are added to the solution set S. Offspring with score 0 implies that it produces no desired output (P(I)∩O=Ø). Such offspring are discarded, based on the previous observation that, applying ExtRule or MkAgg to a program monotonically decreases the output size of the program. This means that further extending any rule of this program would not produce any desired output, except adding new rules. In addition, we assume that in all solution programs, every non-aggregate rule directly contributes to some output in O. Therefore, only rules with non-zero score (P(I)∩O≠Ø) are added into the set of candidate programs (Q) for further mutations.

Algorithm 2 Sample (Q,P). Given a set of candidate programs Q, the current
program P, return a program P′ ϵ Q.

For k ϵ {1 ,2, . . . , Kₘₐₓ}, do:

| | |
|---|---|
| 1. | Uniformly sample a program P′ from Q. |
| 2. | Compute acceptance probability of P′: |
| | 1s₀:= score(P), s₁ := score(P′) |
| | $T := 1 - \frac{k}{{K}_{max}}$ |
| | $Pr [ accept {P}^{′} ] := \{ \begin{matrix}1 & if {s}_{1} > {s}_{0} \\ exp ( - \frac{s 0 - s 1}{T} ) & otherwise\end{matrix} \qquad ( 3 )$ |
| 3. | If Pr[accept P′] ≥ random(0, 1): |
| | return P′ |

In step 2c, the next program to explore is sampled probabilistically. When there are offspring with higher score or higher recall, these offspring will always be chosen as the next program to explore. Otherwise, it samples from the whole set of candidate programs Q. The sub-routine Sample(Q, P) is described in algorithm 2. Borrowing the idea in simulated annealing, it iteratively samples a candidate P′∈Q uniformly, and accept it with probability computed by equation 3. Intuitively, when a candidate program has higher score than current program, it is accepted with probability 1. Otherwise, it is accepted with probability between 0 to 1, depending on how worse its score compared to the current program.

The rest of this section describes each of these mutation strategies, and formal properties of the synthesis algorithm.

### 4.1 Adding and Extending Rules

The AddRule(P) procedure enumerates all minimal rules and generate offspring by adding one minimal rule to P. A minimal rule is a rule that has only one literal in the body, and the head only have one field bound to the body, with all remaining fields being empty place holders (“_”). In the short-path routing example, one of the minimal rules is:
r_0: bestPath(x,_,_,_):-link(x,_,_).

Let MinimalRules be the set of all minimal rules obtained from the given input and output relations, AddRule(P) is defined as:

AddRule(P):={(P∪r)|r∈MinimalRules}(4)

Next we introduce “ExtRule(P)” procedure, which further contains two atomic operations on a rule, namely “AddLiteral(r)” and “AddBinding(r)”. They are defined as:

AddLiteral(r)={rΛl|r∈P,l∈L} (5)

where L is the set of all literals whose relation is from the set of all input relations, output relations, and user-defined functions, and contains only empty place holders “_”. rΛl represents a new rule by adding literal l in conjunction with r's body. Continuing on the example on shortest-path routing, one of the new rules generated by “AddLiteral(r₀)” is:
r_1: bestPath(x,_,_,_):-link(x,_,_),
   bestPath(_,_,_,_).
      where bestPath(_,_,_,_) is a literal instantiated from the output relation bestPath.
      Next, “AddBinding(r)” is defined as follows:

$$\begin{matrix}Add Binding ( r ) = \{ r ∧ ( {v}_{1} = {v}_{2} ) \vert {v}_{1} , {v}_{2} ∈ r \\ ∧ dom ( {v}_{1} ) = d o m ( {v}_{2} ) \}\end{matrix} \qquad ( 6 )$$

where v₁, v₂∈r means that variable v₁ and v₂ appear in the rule r, and dom(v) is the domain of variable v, as specified in the schema of the literal where v appears. As an example, we show one of the rules generated by “AddBinding(r₁)”:
r_2: bestPath(x,_,_,_):-link(x,z,_),
   bestPath(z,_,_,_).
      where the second variable in literal link is bound with the first variable in literal bestPath in the body. Note that instead of explicitly add a predicate that match two variables as:
bestPath(x,_,_):-link(x,v1,_),bestPath(v2,_,_,_),v1=v2, we rename v1 and v2 to z for brevity.

Putting them together, “ExtRule(P)” generates all programs resulted from applying either “AddLiteral” or “AddBinding” to any one of the rules in program P. “ExtRule(P)” is defined as:

ExtRule(P)={(P\r)∪r′|r∈P, (7)
r′∈(AddLiteral(r)∪AddBinding(r))

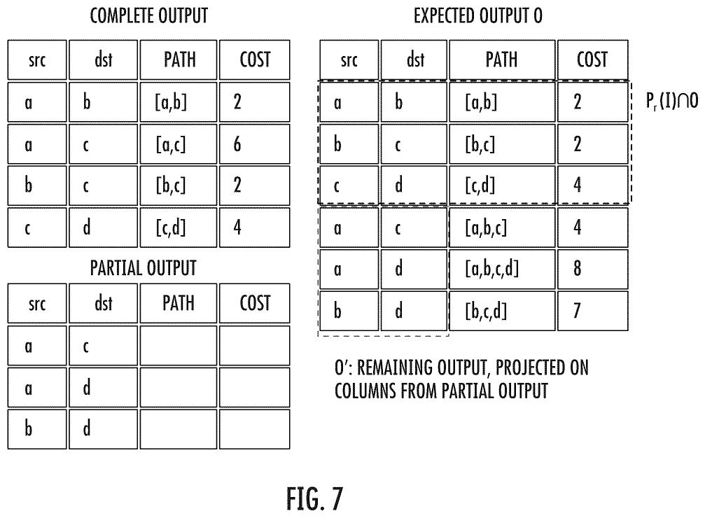

FIG. 7 illustrates an example of scoring a partial program Pr. It contains a partial rule r, where only two fields in the head are determined, thus only two columns are generated by this rule. The precision is 0.86 because 6 out of the 7 output tuples are desired (in O∪πc(O)). Recall is composed of two parts, the complete tuples (the three in the larger dashed rectangle), and the partial tuples (the three in the smaller dashed rectangle). The recall on the partially generated output is discounted by factor 0.5 because only two out of four columns are generated. Putting them together, the total recall is

$$\frac{3 + 3 \times 0.5}{6} = 0.75 .$$

### 4.2 Evaluating Partial Programs

When applying AddRule(P) and ExtRule(P), we will have partial rules in the program queue. By partial rule we mean rules that have empty place holders in the head. We further define partial programs as programs that contains at least one partial rule.

As an example, consider the four-place bestPath(x, y, p, c) relation, and a partial rule as the following:
r_{P1}: bestPath(x,y,_,_):-link(x,z,_),
   bestPath(z,y,__,_),
      Notice that this rule only produces the first two columns of the output relation, the source node and the destination node, but does not produce the remaining two columns, the optimum path, and its length.

As a consequence, programs with these partial rules, such as P∪{rₚ₁}, cannot be directly compared to the entire reference output O, and we are instead only able to compare its first two columns to π_{src,dest}(O), borrowing the notation for projections from relational algebra.

This leads us to the following definition of precision and recall for partial programs Pᵣ:

$$\begin{matrix}{precision}_{d} ( {P}_{r} ) = \frac{\vert {P}_{r} ( I ) ⋂ ( O ⋃ {π}_{c} ( O ) ) \vert}{\vert P ( I ) \vert} , \\ {O}^{′} = \{ t ∈ ( O ∖ P ( I ) ) \vert {π}_{c} ( t ) ∈ P ( I ) \}\end{matrix} \qquad ( 8 )$$

$${recall}_{d} ( {P}_{r} ) = \frac{\vert P ( I ) ∩ O \vert + γ \vert {O}^{′} \vert}{\vert O \vert} \qquad ( 9 )$$

where π_{c} is the projection operator that project to the columns that have been bound on the partial rule's head, The set O′ is the subset O that are not in P(I), but whose projection on columns c appear in P(I), we visualize this set computation in FIG. 7.

### 4.3 Introducing Aggregation Operations

Algorithm 3 MkAgg(P). Procedures offspring
of P by introducing aggregation operators.

| | |
|---|---|
| 1. | Let F be the family of aggregation operations, and Let C be the set of |
| | all columns in output relation R. |
| 2. | For each operator op ∈ F, for each subset C_{agg} ⊆ C, and for each |
| | aggregation column f ∈ C\C_{agg}, construct the offspring program P′: |
| | First rename the output relation R of P to R_{base}, and let Cᵣₑₘ be the |
| | remaining columns C\C_{agg}\{f}. Then add the following two rules. |
| | Rₒₚₜ (C_{agg}, fₒₚₜ): − R_{base} (C_{agg}, fₒₚₜ, _), |
| | fₒₚₜ = op f: R_{base} (C_{agg}, f, _). |
| | R (C_{agg}, fₒₚₜ, Cᵣₑₘ): − Rₒₚₜ (C_{agg}, fₒₚₜ), |
| | R_{base} (C_{agg}, fₒₚₜ, Cᵣₑₘ). |
| 3. | Return all offspring produced in Step 2. |

Algorithm 3 describes MkAgg Procedure. Recall the third program in our running example of FIG. 4:
r1: bestPath(x,y,p,c):-link(x,y,c),p=[x,y].
r2: bestPath(x,y,x::p,c1+c2):-link(x,z,c1),
   bestPath(x,y,p,c2),!(xinp1).

This program correctly predicts the reachability relation, but it produces additional incorrect paths, i.e., it has perfect recall but imperfect precision. In this case, NetSpec attempts to remedy the situation by introducing aggregation operators. It introduces two new rules, which may be informally interpreted as follows: The first rule selects a subset of columns (in this case, the source node x and the destination node y), and performs an aggregation on another column (in this case, computing the minimum of all path weights which share the source and destination nodes). The second rule then selects the values of the remaining columns which lead to this maximization or minimization objective. Thus, after mutation, the following program is added to the queue:
r1: path(x,y,p,c):-link(x,y,c),p=[x,y].
r2: path(x,y,x::p,c1+c2):-link(x,z,c1),
   bestPath(x,y,p,c2),!(xinp1).
   r3: minPath(x,y,mc):-path(x,y,_,mc),
   mc=minc:path(x,y,_,c).
   r4: bestPath(x,y,p,mc):-minPath(x,y,mc),
   path(x,y,p,mc).

### 4.4 Supporting Multiple Input-Output Example Pairs

So far our algorithm description is based on one set of input tuples (I) and one set of output tuples (O). To support multiple instances of examples, NetSpec introduces an additional field ‘InstanceID’ to every tuple, which indicates the particular example instance that the tuple belongs to. Tuples across different instances are then combined into one set of input tuples (I), and one set of output tuples (O), respectively. During the rule search process, NetSpec only generates rules that bind all ‘InstanceID’ fields to one single variable. For example, a rule generated by NetSpec would look like the following:
h(v1,v2,i):-p1(v1,v3,i),p2(v3,v2,i).
   where all variables for ‘InstanceId’ field are bound to the same name i. Thus, the synthesis problem with multiple example instances is reduced to one with single instance, which is solved by Algorithm 1.

### 4.5 Soundness and Completeness

Theorem 1 (Soundness). Given a set of input tuples and a set of output tuples (I,O), when NetSpec terminates, its output S satisfies the following property:

∀p∈S,p(I)=O. (10)

Proof sketch. In algorithm 1, a program p is added to solution set S if and only if score(p)=1 (step 2b). To prove Theorem 1 suffice to show that:

score(p)=1⇒p(I)=O (11)

where score(p) is defined in equation 1. By the definition, when score(p)=1, program output p(I) has perfect precision and recall on the reference output O. This implies that p(I)=0.

Next, we state the completeness property. We first define the program space, using the following definitions:

Definition 1 (Empty program). Program p is an empty pro-gram if and only if it consists of no rule.
Definition 2 (Successor relation). Let → be a binary relation on the set of Datalog programs:

p→q⇔q∈Offspring(p) (12)
Let →* be a binary relation on the set of Datalog programs:

p→*q⇒p→p1→ . . . →pn→q (13)
where n≥0.
   Definition 3 (Output-contributing rule). Given a set of input tuples and a set of output tuples (I,O), a rule r in a program p is an output-contributing rule if r's evaluation result on input I intersects with O.

A special case is for programs with aggregations (either argMax or argMin). If r's output is aggregated, then r's result is compared with renamed tuples in O, whose relations are renamed as r's output relation. In the shortest-path example (FIG. 3B), path relation is aggregated into bestPath, when determining if r1 is contributing to out-put, we rename relations of tuples in O from bestP ath to path, and then check intersection. If r is an aggregation rule, because NetSpec introduces an aggregation (min or max) rule and a selection rule simultaneously to achieve argMin or argMax semantics, r's output is interpreted as the derivation result of both aggregation and selection rules. If the shortest-path example, r3 and r4 are introduced simultaneously, and they are both considered output-contributing rules if the derivation results of r4 intersects with O.

All solutions of NetSpec contain only output-contributing rules. Because, during the rule extension phase in algorithm 1, a candidate program is discarded if the newly extended rule does not produce desired output.

Definition 4 (Program space). Given a set of input tuples and a set of output tuples (I,O), and a set of user-defined functions, let P_{c} be the set of Datalog programs that contain only output-contributing rules (definition 3). The program space is defined as programs in P_{c} that are descendants of the empty program p0:

{p∈P_{c}|p0→*p} (14)

Theorem 2 (Weak completeness). For all input-output tables (I,O), if there exists a program p in the program space (definition 4), such that p terminates on input I within a time bound T, with output O, then NetSpec always returns a solution set S, which contains at least one such program p. Otherwise, it returns an empty solution set S=Ø.

This completeness property is “weak” because it assumes a smaller program space (only rules that derive output tuples, definition 4) than the full program space {p|p0→* p}. For example, in the routing protocol in FIG. 3B, rule r1 generates one-hop paths. Given an input network where all best paths have more than one hop, r1's output has no intersection with the desired output, and is thus discarded by Algorithm 1 (step 2b), although it is part of the solution.

### 5. Handling Incomplete Examples

We now describe the example augmentation process. Given an initial set of input-output examples, when multiple satisfying programs are found, NetSpec searches for a new input example that can differentiate these candidate programs, and asks the user to specify the expected output for this new input example. By actively querying the user for feedback, this allows the system to robustly learn programs even from a set of initially under-specified examples.

Algorithm 4 Sample ( ). Samples new
input tuples for disambiguation.

| 1. | Initialize the set of input tuples I := Ø. | |
|---|---|---|
| 2. | For each input relation R: | |
| | a. | Uniformly sample the number of tuples, n ∈ {1,2, ..., nₘₐₓ}, |
| | | where nₘₐₓ is the upper bound on the size of the sampled tables. |
| | b. | Sample n tuples, t₁, t₂, ..., tₙ, where each tᵢ = (c₁, c₂, ..., cₖ), all |
| | | constants being uniformly sampled, and where k is the arity of |
| | | the relation R. |
| | c. | Insert t₁, t₂, ..., tₙ into I_{R.} |

| | |
|---|---|
| 3. | Return I. |

We describe the core example sampling process in Algorithm 4. In particular, in step 2a), nₘₐₓ is the maximum of the table sizes in the initial example input I. In step 2b), constants are uniformly sampled from the set of all constants, that appear in the initial example input I.

Given a set of candidate programs P₁, P₂, . . . , Pₙ which are consistent on the initial example input I (i.e., P₁(I), P₂(I), . . . , Pₙ(I) match the initial example output), we repeatedly run the sample procedure to obtain k new example inputs, I₁, I₂, . . . , Iₖ. We then choose an example input I_{q}∈{I₁, I₂, . . . , Iₖ} for the user to label the corresponding example output, as follows:

$${I}_{q} = arg {max}_{{I}_{j}} ( - {\sum }_{O} {p}_{O} log ( {p}_{O} ) ) , \qquad ( 15 )$$

where O ranges over the set of example outputs {P₁(Iⱼ), P₂(Iⱼ), . . . , Pₙ(Iⱼ)}, and p_{O} is the fraction of the candidate programs which produce O as output. By maximizing the entropy of the new example, we eliminate as many programs as possible after user feedback. We illustrate this using n=4 candidate programs and k=3 sampled examples {I₁, I₂, I₃}(see 1. Concrete examples: https://github.com/HaoxianChen/netspec/blob/master/docs/active-learning-example.md) such that:
1. The programs are consistent on I₁. Then, O ranges over a singleton set of outputs and p_{O}=1, so the score of I₁ is −(1·1·log(1))=0.
2. The programs are 50-50 split on I₂. Then, O ranges over a set of two distinct outputs and p_{O}=0.5, so the score of I₂ is −(2·0.5·log(0.5))˜0.69.
3. Each program produces a unique output on I₃. Then, O ranges over a set of four distinct outputs and p_{O}=0.25, so the score of I₃ is −(4·0.25·log(0.25))˜1.38.
   Thus, I₃ would be selected as the new example, which corresponds with the intuition that user feedback would eliminate the most (i.e., 3 out of 4) candidate programs.
   We repeat this procedure until the remaining programs can no longer be distinguished by the sampled inputs. This approach is similar to the query-by-committee method [35] and enables NetSpec to rapidly converge to the final solution.
   Theorem 3. Assume NetSpec is always able to disambiguate candidate programs, and that the user always gives correct answers to NetSpec's queries, if there exists a solution p in the program space (Definition 4), then NetSpec always returns solutions that are logically equivalent to p after active-learning.
   Proof sketch. By theorem 2, p is always in the solution set S after every iteration of synthesis. By the assumption that NetSpec is always able to disambiguate candidate programs, a new queries will always be generated to differentiate p from other solutions, until all programs in S are logically equivalent. Therefore, when NetSpec terminates, all solutions are logically equivalent to p.

### 6. Implementation

NetSpec is implemented in Scala and comprises˜3.5K lines of code (see https://github.com/HaoxianChen/netspec). It uses Souffle [38] as the backend Datalog interpreter to validate the candidate specifications. In this section, we discuss implementation details regarding how NetSpec handles non-terminating candidate specifications, and how it synthesizes specifications with constants.
Handling non-terminating specifications. During the synthesis process, NetSpec could encounter non-terminating specifications in the presence of recursion and user-defined functions. For example, consider the following candidate which NetSpec encounters in the process of synthesizing the routing example in Section 2.1:
//computeavailablepaths
r1:path(x,y,p,c):-link(x,y,c),p=[x,y].
r2:path(x,y,x::p1,c1+c2):-link(x,z,c1),
path(z,y,p1,c2).

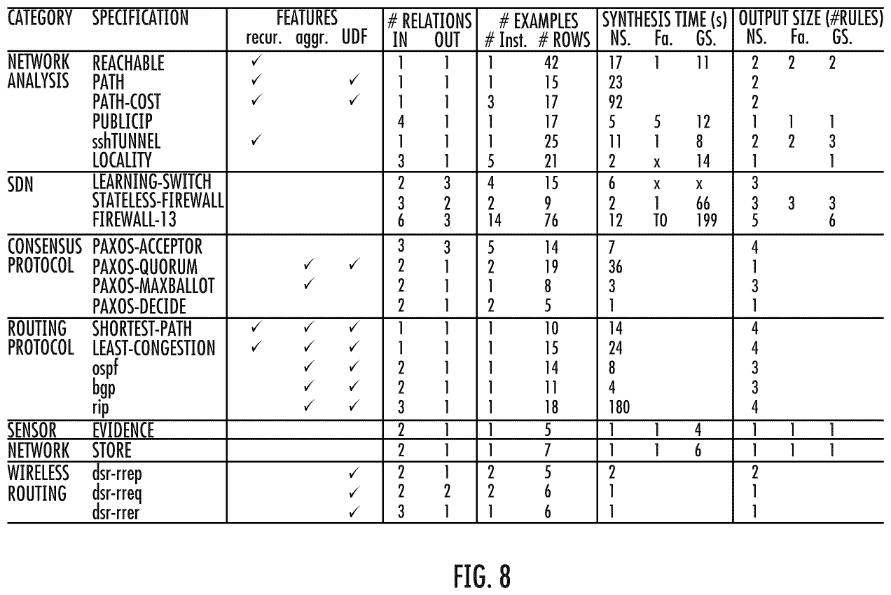

FIG. 8 is a table illustrating synthesis results for benchmarks where the original examples are sufficient. For expressiveness, specifications that use the features of recursion, aggregation, and UDFs are highlighted in the “Features” columns. The “#Relations” shows the number of input and output relations for each specification. The effort of specifying examples is described by the number of input-output instances and the total number of rows in all instances. Column “Time” shows the synthesis time of each tool, measured in seconds. Column “Output size” shows output size of each tool, measured in lines of Datalog rules. Both synthesis time and output sizes are average across 10 runs. NS., Fa., and GS. stand for NetSpec, Facon and GenSynth, respectively. In the “Time” column, x means the tool terminates and finds no solution, and TO means the tool times out after 20 minutes. For benchmarks where the tool is inapplicable, the time and size entries are left empty.

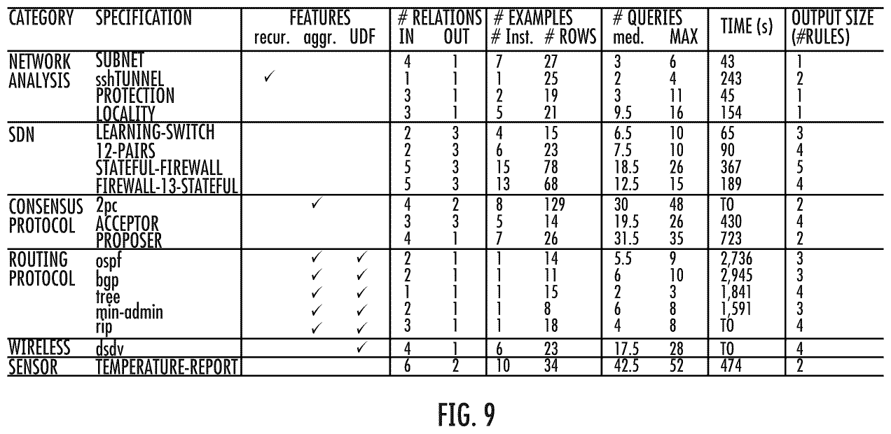

FIG. 9 illustrates active learning results for benchmarks that need example augmentation. NetSpec runs active learning to augment the input-output examples and finds the validated solutions. In the “#Queries” column, “med.” and “max” stand for median and maximum. Column “Time” shows the average end-to-end time. “TO” means timing out after 1 hour. Column “Output size” reports the size of the synthesized specification, measured in the number of Datalog rules.

This specification does not terminate when the input network topology represented by the link relation contains a cycle, since both :: (list prepend) and + (integer addition) used in the recursive rule r2 generate new values every time the rule is evaluated. NetSpec handles such specifications by halting the specification interpreter after a timeout period, and considers their output to be empty.

Generating constants in specification. Many network specifications in practice require constants. For example, in an SDN firewall specification, the controller application monitors and responds only to a certain port. Such a specification cannot be synthesized without the use of constants. On the other hand, naively adding constants into the specification can lead to over-fitting it to the provided input-output examples.

To distinguish specifications where constants are fundamentally needed from those which can be realized symbolically, NetSpec employs a fail-over mechanism: it embarks by only searching for symbolic specifications; when it exhausts the candidate program queue and fails to find a solution, it switches to use constants from the input-output examples. In experiments where NetSpec learns specifications from execution traces (Section 7.3), all firewall applications monitor certain ports on a dedicated switch. On their traces, the fail-over mechanism is triggered and NetSpec synthesizes specifications with constants on the switch and port field.

### 7. Evaluation

Our evaluation aims to answer the following four questions:
1. Expressivity. Is NetSpec able to synthesize a wide range of network specifications correctly, and how does its coverage compare to state-of-the-art synthesis tools?
2. Efficiency. Can NetSpec synthesize a network specification in reasonable time (on the order of seconds)?
3. Robustness. Is NetSpec robust to input-output example quality, in particular, can it handle incomplete examples?
4. Scalability. Can NetSpec learn specifications from examples derived from a large volume of execution traces? Note that this question goes beyond performance to also capture NetSpec's ability to debloat legacy applications.
   Benchmarks. We survey the use of declarative specifications from literature, and organize them into five categories: network analysis, SDN, sensor networks, consensus protocols, and routing protocols. Network analysis refers to prior work on formalizing reachability and other correctness properties in networks [4], [26], [31]. SDN specifications are from works on verifying correctness of controller programs [5], [31]. Sensor network specifications are based on a declarative sensor network system [14]. Consensus protocols [3] and distributed routing are based on declarative specifications targeted for distributed execution [25], [14], and verification [20], [17], [41].
   Input-Output example generation. To provide examples free of bias to any synthesizer, we manually read through the documentation for each benchmark protocol and come up with input-output examples that cover all the use scenarios described in the documentation. The example size is measured by the number of input-output example instances (i.e., groups of input-output tables), and the number of total tuples (i.e., number of rows in relational tables) in all instances, as shown in the “#Examples” column in FIG. 8.
   Result Validation. A synthesis result is correct if it is identical to the reference specification after two modifications: (1) variable renaming, and (2) removing redundant predicates and rules (if any). We manually validate all experiment results. Reference [1] illustrates how each benchmark is validated, and has synthesis results of all experiments. Modification (1) dominates the validation process and a few results require modification (2). In the remainder of this section, we refer to such results as validated solutions.

The rest of the section are structured as follows. In Section 7.1, we evaluate NetSpec's expressivity and efficiency by comparing with state-of-the-art program synthesis tools. In Section 7.2, we evaluate NetSpec's robustness to input-output example quality, on benchmarks with insufficient examples. In Section 7.3, we evaluate NetSpec's scalability on execution traces that consist of thousands of examples.

### 7.1 Synthesis Expressivity and Efficiency

We first evaluate expressivity and synthesis efficiency given sufficient examples. We compare NetSpec to two state-of-the-art tools, Facon [13] and GenSynth [28].

Applicable benchmarks. Like NetSpec, both Facon and GenSynth operate on relational input-output data. However, they are less expressive: neither tools support UDFs and aggregation. Therefore, we only run these tools on benchmarks that they apply to. In addition, some of the original benchmark specifications may have insufficient examples, i.e., missing corner cases and resulting in incorrect specifications. To evaluate synthesis efficiency and compare with baselines that do not augment examples, this section focuses on benchmarks with sufficient examples for this experiment (FIG. 8), where NetSpec returns validated solutions for at least 8 out of 10 repeated runs. We will revisit applications with insufficient examples in Section 7.2.

In addition, GenSynth does not support multiple instances of examples. We therefore combine the multiple instances into a single instance by unioning tuples that belong to the same relation into the same table. We avoid introducing spurious correlations across the original instances by renaming constants appropriately. Note that this process is challenging to automate since certain constants (e.g., port numbers) are global and must not be renamed. This highlights the benefit of supporting multiple example instances as well as constants in NetSpec.

Performance metric. We measure NetSpec's expressivity in terms of coverage of different network specifications from the areas of network analysis, SDN, sensor networks, consensus protocols, and routing protocols. To evaluate synthesis efficiency, we measure the end-to-end synthesis time, on a server with 32 2.6 GHz cores and 125 GB memory. Both NetSpec and Facon run in single thread. GenSynth, however, often runs indefinitely long in single thread, due to its high degree of nondeterminism. Therefore, we run GenSynth in 8-thread mode in order to obtain results within 20 minutes each.
Results. FIG. 8 summarizes our overall results. Focusing on the first two criteria of expressivity and efficiency, our main takeaways are as follows:
Expressivity. NetSpec successfully synthesizes all 23 benchmarks in FIG. 8, spanning different types of network protocols. On the other hand, due to limited language feature support, competing solutions such as Facon [13] and GenSynth [28] support only 9 benchmarks. In addition, Facon fails to synthesize the locality benchmark because it lies outside of Facon's program search space, which only contains Datalog rules where each relation appears at most once. Both Facon and GenSynth fails to synthesize learning-switch benchmark due to the lack of support for negation.
Efficiency. NetSpec is highly efficient. NetSpec finishes most benchmarks within one minute, with the exception of path-cost and the RIP protocols, which takes 92 seconds and 3 minutes, respectively. On the other hand, Facon is only able to synthesize 8 out of 10 applicable benchmarks, and in fact, two benchmarks timed out after 20 minutes. Compared to GenSynth, NetSpec consistently finishes faster on all applicable benchmarks, except reachable and sshTunnel, where NetSpec takes 6 seconds and 3 seconds longer respectively. This is impressive since NetSpec runs in single thread whereas GenSynth in 8.
Benefits of component-based synthesis. Our benchmarks also showcase the benefits of synthesis in a component-based fashion. We describe case studies based on two protocols: PAXOS (paxos-* in the FIG. 8) and DSR (dsr-*) in FIG. 8. The original specification of PAXOS lies contains two layers of aggregations (first count the votes to determine which ballot has a quorum, and then decide a value by choosing the one with the maximum ballot value). In normal circumstances, this is beyond NetSpec's search capabilities since it can only synthesize programs with at most one layer of aggregations. However, by breaking PAXOS into different components, synthesis is not only possible but done efficiently.

DSR, on the other hand, can be synthesized as one monolithic protocol. Yet, by breaking its synthesis into component modules, it significantly reduces the number of examples to sufficiently specify the protocol. DSR handles three different kinds of input messages independently, thus it gives the opportunity to break down the synthesis task into independent modules. For example, when synthesizing a rule to process route request message, the synthesizer does not need to consider any input value of a route error message. On the other hand, if examples for all types of message handling are combined together, although NetSpec can still efficiently find a solution, but it will generate a lot of invalid solutions (consistent with input-output examples but not equivalent to the reference solution) due to the larger program space. We note that component-based synthesis strategy for DSR is not only complete, but also highly efficient.

### 7.2 Robustness to Insufficient Examples

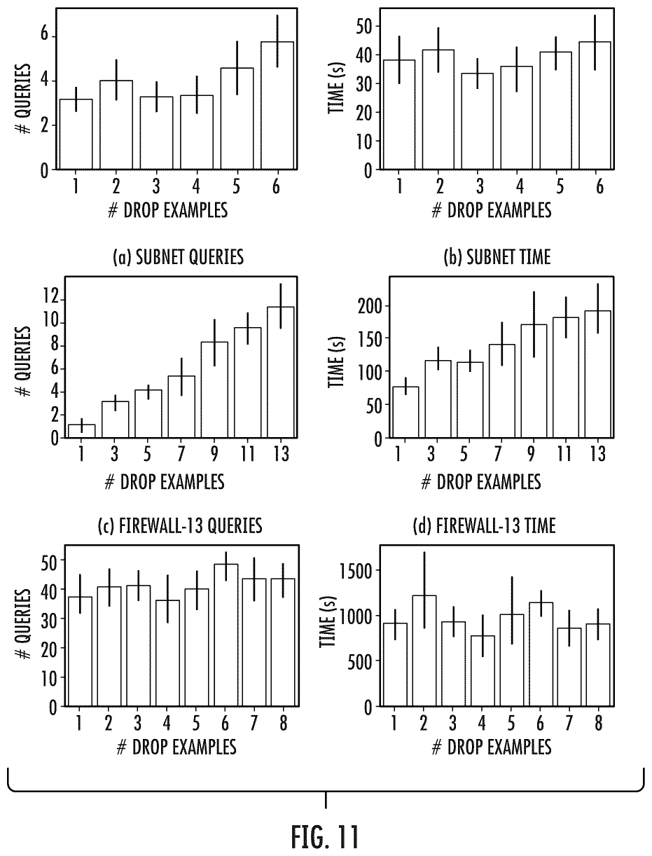

We evaluate NetSpec's robustness to insufficient examples on two kinds of benchmarks: (1) benchmarks with insufficient examples (FIG. 9); (2) benchmarks with sufficient original examples, but some of the examples are randomly dropped to test NetSpec's limit (FIG. 11).

Handling insufficient examples. For each benchmark in FIG. 9, we run NetSpec with active learning, which iteratively queries the user with extra input examples, until it finds no ambiguities in the examples. solves more benchmarks as the number of random samples in active learning increases.

To determine the number of random samples in active learning phase (Section 5), we gradually increase the sample number from one to a million, and measure the number of benchmarks solved by NetSpec. Due to the randomness of the active learning algorithm, a benchmark is determined successful if NetSpec returns validated solutions in all 10 repeated experiment runs.

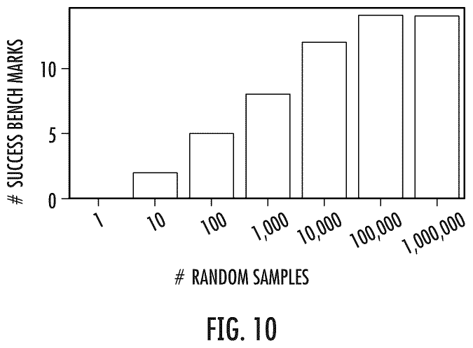

FIG. 10 shows the results, where NetSpec's performance saturates at 100K samples, with 15 out of 18 benchmarks succeeding. The remaining three benchmarks involve the most complex specifications. They timed out and return incorrect specifications (consistent with input-output examples but different from the reference). The time bound is introduced because NetSpec is designed for interactive use. Recall that the active-learning phase involves multiple iterations of specification synthesis and new input example generation, whose output is annotated by protocol designers. Since increasing the sampling parameter beyond 100K does not reduce the end-to-end time (i.e., does not helping to solve more benchmarks within the time budget), we use 100K as the number of random samples for our remaining experiments.

FIG. 9 shows the detailed statistics of the active learning experiments. The number of queries varies across different benchmarks, with the median ranging from 2 to 42.5. Similarly, the end-to-end time ranges from 43 seconds to 2,945 seconds across benchmarks.

For the three benchmarks (2pc, rip, and dsdv) that timed out, their relations compose a much larger program space (rules with many predicates and aggregators), and thus more examples are needed to unambiguously specify a program. This results in too many iterations in active learning, which is a limitation of input-output example based interface. Synthesizing correct specifications for them require either reducing the number of queries or improving synthesis efficiency, which remains an interesting avenue of future work.

Randomly omitted examples. We further stress test NetSpec by randomly dropping examples. Three benchmarks with at least seven examples are chosen for this experiment. For each of them, examples are dropped incrementally until reaching the most extreme case, where every output relation appears in only one example instance. Otherwise, an output relation is missed from all examples, and NetSpec would skip synthesizing rules for the relation, thus returning an incomplete program.

FIG. 11 presents the distributions of the number of queries and the end-to-end active learning times for each benchmark across ten repeated runs. The number of queries shows positive correlation with the number of dropped examples with one exception. Benchmark “temperature-report” shows weaker correlation because each active learning run takes more queries (40±5) than the original example set size (9). Hence, the impact of dropping examples is weaker than benchmarks where the overall number of queries are smaller.

For relationship between end-to-end time and the number of dropped examples, “firewall-13” shows strong positive correlation. The “temperature-report” shows no such correlation, which is expected since its query numbers is not correlated with the number of dropped examples (FIG. 11, graph (e)). On the other hand, for the “subnet” benchmark, although the number of dropped examples has strong correlation with the number of queries (FIG. 11 graph (a)), the correlation with time (FIG. 11, graph (b)) is weaker. This is because the end-to-end time is dominated by the synthesis time of the final few runs (where examples are almost sufficient). The earlier runs are fast because, with just a few examples left, NetSpec can quickly find superficial solutions and query new examples. When examples are sufficient, the solution becomes much more complex (more literals in a rule). This complexity, coupled with the randomness of the synthesis algorithm, leads to larger variation in synthesis time.

In the “subnet” and “temperate-report” benchmarks NetSpec, recovers validated specifications consistently (100%), even under extreme cases where only 1 is example is left. “Firewall-I3”, on the other hand, fails when examples for particular message types are all dropped. For instance, if no example responds to ARP packets, then all candidate programs would just ignore ARP packets, because NetSpec discard rules that derive no reference output, although the reference program actually handles ARP packets. In practice, however, it is rare that a protocol designer provides no examples for a typical type of output at all.

Overall, NetSpec's active learning mechanism is effective in improving example quality and finding validated solutions. General differential testing of programs is a hard problem. However, by separating protocol logic from implementation details, declarative specifications drastically reduce the search space to differentiate alternative specifications. By exploiting the simplicity of declarative specifications, NetSpec's simple random testing mechanism is able to effectively disambiguate alternative protocol specifications.

| | | | | #Queries | | Time |
|---|---|---|---|---|---|---|
| Program | LOC | #T | #R | med. | max | (s) |
| Floodlight stateless firewall | 216 | 895 | 5 | 8 | 9 | 188 |
| Floodlight stateful firewall | 233 | 121 | 7 | 23 | 25 | 468 |
| POX I3 stateless firewall | 97 | 185 | 5 | 10 | 12 | 79 |
| POX I3 stateful firewall | 107 | 4,591 | 6 | 22.5 | 26 | 505 |
| POX learning-switch | 98 | 334 | 4 | 6 | 10 | 2,295 |

TABLE 1: Learning specifications from program communication traces. Column “#T” measures the number of in-put output messages in the execution trace, column “#R” measures the number of rules of the reference specification, column “#Queries” measure the median and maximum number of queries posted by NetSpec, across 10 repeated experiments, and column “Time” shows the average end-to-end active learning time.

### 7.3 Learning from Program Traces

In our final experiment, we explore NetSpec's ability to directly synthesize from actual execution traces as input-output examples. The benefits of this approach are two-fold. First, for code refactoring or program analysis, the generated specifications expose the essential logic of the program, and can serve as a formal model for further analysis. Second, the logic specifications can be compiled into a more compact and less bloated program for execution.

Trace collection. We collect program communication traces from two popular SDN platforms, POX [32] and Floodlight [19], on which we run controller programs and collect its communication traces with the switches in the network. We select SDN platforms as a basis for this experiment due to readily available open-source implementations that match our benchmarks.

To generate input-output examples, we generate representative traffic loads that we inject into each SDN controller program. Based on the inputs, we capture the outputs by observing the SDN programs. For instance, for learning switches, all hosts send probe packets to establish full connectivity in the network. For firewalls, we divide the network into two zones, one protected by the firewall, and the other serving as the external network. We then randomly pick hosts from either side of the network to establish TCP sessions. We validate the functionality of the firewall by checking that only sessions initiated from internal hosts are successfully established.

Trace collection is done by running the controller programs in both POX and Floodlight on the Mininet [29] emulator. All Mininet topologies are setup on a 16-node, 8-switch, tree topology network. For each run, we collect the controller's input-output traces as it interacts with Mininet switches (via incoming/outgoing packets and flow modifications). In all our experiments, we observe that this setup suffices to collect enough examples for NetSpec to learn a validated specification, with additional queries to user.

We implemented a trace collector on both POX and Floodlight that collects the controller's input and output messages at run-time and the state changes to the program. The state monitor works as follows. Within each application's input packet handler, we inspect all the accessible global variables. We then record any changes to such global variables. We exclude the known global constructs that are irrelevant to each application's execution logic, like loggers.

Table 4 summarizes the results. We make the following observations. First, NetSpec is able to correctly synthesize the intended specifications for all applications. Second, even though traces contain up to 4,500 communication messages, additional queries are needed to augment the examples. This observation shows the practicability of NetSpec's example augmentation mechanism in helping user uncover corner cases. Third, even for non-trivial SDN applications with hundreds of lines of code, NetSpec is able to generate compact specifications with less than seven rules. Finally, the synthesis times are in the order of hundreds of seconds, except “learning-switch” at 2,295 seconds, despite the need to analyze actual communication traces with up to 4591 examples, and generate multiple queries, indicating the efficiency and scalability of our approach.

### 8. Related Work

Programming by example. NetEgg [44] enables programming SDN policies by example timing diagrams. NetEgg demonstrates via actual user studies that a programming-by-example paradigm can result in higher programming productivity and fewer errors. One exemplary distinction is that NetSpec synthesizes the actual control plane program in the target DSL, which generates the data plane configurations, whereas NetEgg directly generates the data plane configurations. This target DSL can be used to verify and check for errors in the control plane program, whereas NetEgg can only provide counter-examples to indicate that the input examples are incorrect. NetSpec mitigates one inherent weakness of NetEgg in its reliance on the user to provide all possible examples that meet the scenarios. Facon [13] is a programming-by-example tool for synthesizing SDN programs. NetSpec employs a more scalable synthesis strategy, targets a more general logical model, and can handle more complex protocols and incomplete examples.

Network configuration synthesis. Taking high-level routing policies as input, NetComplete [17] synthesizes BGP configurations that comply with these policies, and Genesis [39] synthesizes forwarding tables in multi-tenant networks. Avenir [10] synthesizes SDN data plane operations from high-level forwarding specifications. Propane [7] compiles high-level routing policies into distributed router BGP configurations. In contrast, NetSpec uses input-output examples, or execution traces from legacy programs, as input, and generate executable protocol specifications that are consistent with given input-output examples.

Config2Spec [8] takes network configurations and a failure model as input, and generates network policies that should hold for all possible concrete data planes derived from the given configurations and failure model. On the other hand, NetSpec generates executable specifications (analysis rules), instead of the static policies (facts derived from analysis rules). NetSpec can complement Config2Spec when analysis tools for the interested policies are not available. NetSpec takes the concrete data plane and the set of satisfied policies as input, and generates data plane analysis rules that can be applied to all concrete data planes. For example, in section 7.1, we show that NetSpec can generate reachability analysis rules similar to what is used by Config2Spec when inferring reachability policies.

Datalog and logic program synthesis. A large body of work has proposed techniques to synthesize logic programs [15] from input-output examples. With the exception of GenSynth, existing techniques require the user to syntactically constrain the search space by means of specifications such as mode declarations (e.g. ILASP [24]), meta-rules (e.g. Metagol [16]), candidate rules (e.g. ALPS [36] and ProSynth [33]), or templates (e.g. NTP [34] and SILP [18]). NetSpec does not require the user to provide any such specifications, but with the trade-off to require more input-output examples to fully specify an intended program. However, with the help of active-learning, as our evaluation demonstrates, NetSpec synthesizes more general programs than GenSynth, and is more efficient and robust.
Network verification and domain-specific languages. There is significant prior work on network verification [22], [6], [40], [41] and DSLs for networking [31], [21], [23], [5]. NetSpec generates a logical network specification that can be verified using existing techniques. Hence, verification should be viewed as a complementary technology to NetSpec. The same benefits of having a restricted language, such as scalable synthesis and automated example augmentation, apply to other DSLs as well.

### 9. Conclusion

NetSpec addresses a long-standing problem in network verification: the widening gap between formal models and actual implementations. As a step towards closing the gap, we have proposed a new specification by example (SBE) toolkit where users can build formal models of their network protocols from input-output examples either supplied by the network designer or extracted from a legacy implementation. Our synthesized models are declarative logic programs which are amenable to formal verification and even generation of distributed implementations.

Our initial forays and experimental results are promising. The SBE approach can efficiently synthesize a wide range of network protocols, and is robust to missing examples. NetSpec should be viewed as a first step towards understanding the SBE paradigm and its application in different domains of networking, with limitations in the size of synthesized specifications and complexities. In the future, we plan to explore how to synthesize more complex specifications, methods for parallelizing the synthesis algorithms to handle larger specifications, and how SBE can interact with different formal verification techniques.

### REFERENCES

The disclosure of each of the following references is incorporated herein by reference in its entirety.
[1] Netspec synthesis result validation. https://github.com/HaoxianChen/netspec/blob/master/synthesis-validation.
[2] Serge Abiteboul, Richard Hull, and Victor Vianu. Foundations of Databases: The Logical Level. Pearson, 1st edition, 1994.
[3] Peter Alvaro, Tyson Condie, Neil Conway, Joseph M Hellerstein, and Russell Sears. I do declare: Consensus in a logic language. ACM SIGOPS Operating Systems Review, 2010.
[4] John Backes, Sam Bayless, Byron Cook, Catherine Dodge, Andrew Gacek, Alan J Hu, Temesghen Kahsai, Bill Kocik, Evgenii Kotelnikov, Jure Kukovec, et al. Reachability analysis for aws-based networks. In International Conference on Computer Aided Verification, 2019.
[5] Thomas Ball, Nikolaj Bjorner, Aaron Gember, Shachar Itzhaky, Aleksandr Karbyshev, Mooly Sagiv, Michael Schapira, and Asaf Valadarsky. Vericon: towards verifying controller programs in software-defined networks. In PLDI, 2014.
[6] Ryan Beckett, Aarti Gupta, Ratul Mahajan, and David Walker. A general approach to network configuration verification. In Proceedings of the Conference of the ACM Special Interest Group on Data Communication, 2017.
[7] Ryan Beckett, Ratul Mahajan, Todd Millstein, Jitendra Padhye, and David Walker. Don't mind the gap: Bridging network-wide objectives and device-level configurations. In Proceedings of the 2016 ACM SIGCOMM Conference, 2016.
[8]Rüdiger Birkner, Dana Drachsler-Cohen, Laurent Vanbever, and Martin Vechev. Config2spec: Mining network specifications from network configurations. In 17th {USENIX}Symposium on Networked Systems Design and Implementation ({NSDI}20), 2020.
[9] Nikolaj Bjorner and Karthick Jayaraman. Checking cloud contracts in microsoft azure. In International Conference on Distributed Computing and Internet Technology, 2015.
[10] Eric Hayden Campbell, William T Hallahan, Priya Srikumar, Carmelo Cascone, Jed Liu, Vignesh Ramamurthy, Hossein Hojjat, Ruzica Piskac, Robert Soule', and Nate Foster. Avenir: Managing data plane diversity with control plane synthesis. In NSDI, 2021.
[11] Ang Chen, Yang Wu, Andreas Haeberlen, Wenchao Zhou, and Boon Thau Loo. The good, the bad, and the differences: Better network diagnostics with differential provenance. In Proceedings of the 2016 ACM SIGCOMM Conference, 2016.
[12] Chen, Limin Jia, Hao Xu, Cheng Luo, Wenchao Zhou, and Boon Thau Loo. A program logic for verifying secure routing protocols. In International Conference on Formal Techniques for Distributed Objects, Components, and Systems, 2014.
[13] Haoxian Chen, Anduo Wang, and Boon Thau Loo. Towards example-guided network synthesis. In Proceedings of the 2nd Asia-Pacific Workshop on Networking, 2018.
[14] David Chu, Lucian Popa, Arsalan Tavakoli, Joseph M Hellerstein, Philip Levis, Scott Shenker, and Ion Stoica. The design and implementation of a declarative sensor network system. In Proceedings of the 5th international conference on Embedded networked sensor systems, 2007.
[15] Andrew Cropper, Sebastijan Dumancic, and Stephen H. Muggleton. Turning 30: New ideas in inductive logic programming. In Proceedings of the International Joint Conference on Artificial Intelligence (IJCAI), 2020.
[16] Andrew Cropper and Stephen H. Muggleton. Metagol system. https://github.com/metagol/metagol, 2016.
[17] Ahmed EI-Hassany, Petar Tsankov, Laurent Vanbever, and Martin Vechev. Netcomplete: Practical network-wide configuration synthesis with autocompletion. In 15th {USENIX}Symposium on Networked Systems Design and Implementation ({NSDI}18), 2018.
[18] Richard Evans and Edward Grefenstette. Learning explanatory rules from noisy data. Journal of Artificial Intelligence Research, 61, 2018.
[19] Floodlight. 2020. http://www.projectfloodlight.org/floodlight/.
[20] Ari Fogel, Stanley Fung, Luis Pedrosa, Meg Walraed-Sullivan, Ramesh Govindan, Ratul Mahajan, and Todd Millstein. A general approach to network configuration analysis. In 12th {USENIX}symposium on networked systems design and implementation ({NSDI}15), 2015.
[21] Nate Foster, Rob Harrison, Michael J Freedman, Christopher Monsanto, Jennifer Rexford, Alec Story, and David Walker. Frenetic: A network programming language. ACM Sigplan Notices, (9), 2011.
[22] Ahmed Khurshid, Xuan Zou, Wenxuan Zhou, Matthew Caesar, and P Brighten Godfrey. Veriflow: Verifying network-wide invariants in real time. In 10th {USENIX}Symposium on Networked Systems Design and Implementation ({NSDI}13), 2013.
[23] Hyojoon Kim, Joshua Reich, Arpit Gupta, Muhammad Shahbaz, Nick Feamster, and Russ Clark. Kinetic: Verifiable dynamic network control. In 12th {USENIX}Symposium on Networked Systems Design and Implementation ({NSDI}15), 2015.
[24] Mark Law, Alessandra Russo, and Krysia Broda. The ilasp system for inductive learning of answer set programs. arXiv preprint arXiv:2005.00904, 2020.
[25] Boon Thau Loo, Tyson Condie, Minos Garofalakis, David E Gay, Joseph M Hellerstein, Petros Maniatis, Raghu Ramakrishnan, Timothy Roscoe, and Ion Stoica. Declarative networking. Communications of the ACM, 2009.
[26] Nuno P Lopes, Nikolaj Bjorner, Patrice Godefroid, Karthick Jayaraman, and George Varghese. Checking beliefs in dynamic networks. In 12th {USENIX}Symposium on Networked Systems Design and Implementation ({NSDI}15), 2015.
[27] William M McKeeman. Differential testing for software. Digital Technical Journal, 1998.
[28] Jonathan Mendelson, Aaditya Naik, Mukund Ragothaman, and Mayur Naik. Gensynth: Synthesizing datalog programs without language bias. Proceedings of the Conference on Artificial Intelligence (AAAI), 2021.
[29] Mininet. http://mininet.org/.
[30] Stephen Muggleton and Luc De Raedt. Inductive logic programming: Theory and methods. The Journal of Logic Programming, 19, 1994.
[31] Tim Nelson, Andrew D Ferguson, Michael J G Scheer, and Shriram Krishnamurthi. Tierless programming and reasoning for software-defined networks. In 11th {USENIX}Symposium on Networked Systems Design and Implementation ({NSDI}14), 2014.
[32] POX. 2020. https://github.com/noxrepo/pox.
[33] Mukund Raghothaman, Jonathan Mendelson, David Zhao, Mayur Naik, and Bernhard Scholz. Provenance-guided synthesis of datalog programs. Proceedings of the ACM on Programming Languages, 2020.
[34] Tim Rockta” schel and Sebastian Riedel. End-to-end differentiable proving. In Proceedings of the Advances in Neural Information Processing Systems (NeurIPS), 2017.
[35]H. S. Seung, M. Opper, and H. Sompolinsky. Query by committee. In Proceedings of the 5th Annual Workshop on Computational Learning Theory (COLT'92), 1992.
[36] Xujie Si, Woosuk Lee, Richard Zhang, Aws Albarghouthi, Paraschos Koutris, and Mayur Naik. Syntax-guided synthesis of Datalog programs. In Proceedings of the Joint Meeting on European Software Engineering Conference and Symposium on the Foundations of Software Engineering (ESEC/FSE), 2018.
[37] Atul Singh, Tathagata Das, Petros Maniatis, Peter Druschel, and Timothy Roscoe. Bft protocols under fire. In NSDI, 2008.
[38] Souffle. 2020. https://souffle-lang.github.io/index.html.
[39] Kausik Subramanian, Loris D'Antoni, and Aditya Akella. Genesis: Synthesizing forwarding tables in multi-tenant networks. In Proceedings of the 44th ACM SIGPLAN Symposium on Principles of Programming Languages, 2017.
[40] Anduo Wang, Prithwish Basu, Boon Thau Loo, and Oleg Sokolsky. Declarative network verification. In International Symposium on Practical Aspects of Declarative Languages. Springer.
[41] Anduo Wang, Limin Jia, Wenchao Zhou, Yiqing Ren, Boon Thau Loo, Jennifer Rexford, Vivek Nigam, Andre Scedrov, and Carolyn Talcott. Fsr: Formal analysis and implementation toolkit for safe interdomain routing. IEEE/ACM Transactions on Networking, 2012.
[42] Chenglong Wang, Alvin Cheung, and Rastislav Bodik. Synthesizing highly expressive SQL queries from input-output examples. In Proceedings of the 38th ACM SIGPLAN Conference on Programming Language Design and Implementation, 2017.
[43] Yang Wu, Ang Chen, Andreas Haeberlen, Wenchao Zhou, and Boon Thau Loo. Automated network repair with meta provenance. In Proceedings of the 14th ACM Workshop on Hot Topics in Networks, 2015.
[44] Yifei Yuan, Dong Lin, Rajeev Alur, and Boon Thau Loo. Scenario-based programming for sdn policies. In Proceedings of the 11th ACM Conference on Emerging Networking Experiments and Technologies, 2015.
[45] Wenchao Zhou, Micah Sherr, Tao, Xiaozhou Li, Boon Thau Loo, and Yun Mao. Efficient querying and maintenance of network provenance at internet-scale. In Proceedings of the 2010 ACM SIGMOD International Conference on Management of data, 2010.

Various combinations and sub-combinations of the structures and features described herein are contemplated and will be apparent to a skilled person having knowledge of this disclosure. Any of the various features and elements as disclosed herein may be combined with one or more other disclosed features and elements unless indicated to the contrary herein. Correspondingly, the subject matter as hereinafter claimed is intended to be broadly construed and interpreted, as including all such variations, modifications and alternative examples, within its scope and including equivalents of the claims. It is understood that various details of the presently disclosed subject matter may be changed without departing from the scope of the presently disclosed subject matter. Furthermore, the foregoing description is for the purpose of illustration only, and not for the purpose of limitation

What is claimed is:

1. A system for synthesizing network specifications using input and output examples, the system comprising:
a processor; and
a memory; and
a network specification synthesizer (NSS) implemented using the processor and the memory, wherein the NSS is configured for receiving input and output examples associated with a network protocol; generating, using the input and output examples and a synthesis algorithm, a logical specification defining the network protocol, wherein the logical specification includes a set of rules; and outputting the logical specification.

2. The system of claim 1 wherein the synthesis algorithm comprises:
detecting incompleteness in the input and output examples used in generating the logical specification;
generating a supplemental input example usable for generating the logical specification;
requesting and receiving, from a user, a supplemental output example corresponding to the supplemental input example; and
utilizing the supplemental input and output examples in generating the logical specification.

3. The system of claim 1 wherein the synthesis algorithm utilizes a best-first search algorithm that incrementally explores an unbounded search space in synthesizing the set of rules of the logical specification.

4. The system of claim 3 wherein the best-first search algorithm comprises:
performing an iterative loop until a stop condition is reached, the iterative loop including:
mutating, using at least one mutation strategy, a first candidate specification to generate a plurality of offspring candidates, wherein each of the plurality of offspring candidates are scored; and
selecting, from the plurality of offspring candidates and using scores of the plurality of offspring candidates, a second candidate specification to mutate.

5. The system of claim 4 wherein the second candidate specification to mutate is selected from offspring candidates of the plurality of offspring candidates that have higher scores or is selected from the plurality of offspring candidates when none of the plurality of offspring candidates has a higher score.

6. The system of claim 4 wherein the at least one mutation strategy includes adding a new rule, extending an existing rule, or applying an aggregation operator.

7. The system of claim 1 wherein the input and output examples include a first input example and a first output example, wherein the first input example includes network information, topology information, virtual machine (VM) configuration information, link cost information, or a weighted directed graph and the first output example includes network state information, shortest or best path information, or reachable VM pair information.

8. The system of claim 1 wherein the NSS is configured for utilizing traces or monitoring of runtime executions of the network protocol to obtain or derive the input and output examples.

9. The system of claim 1 wherein the NSS is configured for using the logical specification for verification, analysis, or prototyping purposes; or wherein the NSS is configured for executing, using a compiler or interpreter, the logical specification and monitoring the execution of the logical specification for issues.

10. The system of claim 1 wherein the logical specification is expressed using a declarative logic programming language, Datalog, or an extended Datalog like language.

11. A method for synthesizing network specifications using input and output examples, the method comprising:
receiving input and output examples associated with a network protocol;
generating, using the input and output examples and a synthesis algorithm, a logical specification defining the network protocol, wherein the logical specification includes a set of rules; and
outputting the logical specification.

12. The method of claim 11 wherein the synthesis algorithm comprises:
detecting incompleteness in the input and output examples used in generating the logical specification;
generating a supplemental input example usable for generating the logical specification;
requesting and receiving, from a user, a supplemental output example corresponding to the supplemental input example; and
utilizing the supplemental input and output examples in generating the logical specification.

13. The method of claim 11 wherein the synthesis algorithm utilizes a best-first search algorithm that incrementally explores an unbounded search space in synthesizing the set of rules of the logical specification.

14. The method of claim 13 wherein the best-first search algorithm comprises:
performing an iterative loop until a stop condition is reached, the iterative loop including:
mutating, using at least one mutation strategy, a first candidate specification to generate a plurality of offspring candidates, wherein each of the plurality of offspring candidates are scored; and
selecting, from the plurality of offspring candidates and using scores of the plurality of offspring candidates, a second candidate specification to mutate.

15. The method of claim 14 wherein the at least one mutation strategy includes adding a new rule, extending an existing rule, or applying an aggregation operator.

16. The method of claim 14 wherein the second candidate specification to mutate is selected from offspring candidates of the plurality of offspring candidates that have higher scores or is selected from the plurality of offspring candidates when none of the plurality of offspring candidates has a higher score.

17. The method of claim 11 wherein the input and output examples include a first input example and a first output example, wherein the first input example includes network information, topology information, virtual machine (VM) configuration information, link cost information, or a weighted directed graph and the first output example includes network state information, shortest or best path information, or reachable VM pair information.

18. The method of claim 11 comprising:
using the logical specification for verification, analysis, or prototyping purposes; or
executing, using a compiler or interpreter, the logical specification and monitoring the execution of the logical specification for issues.

19. The method of claim 11 wherein the logical specification is expressed using a declarative logic programming language, Datalog, or an extended Datalog like language.

20. A non-transitory computer readable medium having stored thereon executable instructions that when executed by a processor of a computer causes a computer to perform steps comprising:
receiving input and output examples associated with a network protocol;
generating, using the input and output examples and a synthesis algorithm, a logical specification defining the network protocol, wherein the logical specification includes a set of rules; and
outputting the logical specification.
